(19) United States
(12) Patent Application Publication
(10) Pub. No.: US 2026/0328690 A1
(43) Pub. Date: Oct. 22, 2026

(54) Light Amount Measuring Device And Program

(71) Applicant: A&T CORPORATION, Fujisawa-shi (JP)

(72) Inventors: Shigeki YOSHIHARA, Fujisawa-shi (JP); Ichiro KUBO, Fujisawa-shi (JP); Shinya KONPARU, Fujisawa-shi (JP); Yu MUNAKATA, Fujisawa-shi (JP)

(21) Appl. No.: 19/572,943

(22) Filed: Mar. 20, 2026

(30) Foreign Application Priority Data
Apr. 17, 2025 (JP) 2025-068119

(51) Int. Cl. G01N 21/64

(52) U.S. Cl. CPC G01N 21/6456; G01N 2021/6463

(57) ABSTRACT

A light amount measuring device is provided. The light amount measuring device includes: a light emitting portion configured to irradiate an object with excitation light; an optical path through which light emitted from the object passes; a light receiving portion configured to receive the light passing through the optical path; and a shutter disposed on the optical path and configured to switch between an open state that allows passage of the light and a blocked state that does not allow passage of the light, the light amount measuring device being configured to measure a light amount of the light passing through the optical path while repeatedly switching between the open state and the blocked state.

### CROSS REFERENCE TO RELATED APPLICATIONS

The present application claims priority under 35 U.S.C. §119 to Japanese Patent Application No. 2025-068119, filed Apr. 17, 2025, the contents of which are incorporated herein by reference in their entirety.

### BACKGROUND

### Technical Field

The present disclosure relates to a light amount measuring device and a program.

### Related Art

JP2017-161929 A discloses a shutter assembly for protecting a high-sensitivity photodetector from harmful exposure to light.

In this shutter assembly, a first shutter blade includes a first toothed arm and a first opening, a second shutter blade is provided adjacent to and parallel to the first shutter blade, the second shutter blade includes a second toothed arm and a second opening, the first shutter blade and the second shutter blade are supported so as to be able to move linearly in parallel, a motor includes a gear disposed to mesh between the first and second toothed arms, rotation of the gear causes the first and second shutter blades to linearly move in opposite directions between an open position and a closed position, the first and second openings overlap each other in the open position, and the first and second openings do not overlap each other in the closed position.

In addition, JP2005-091346 A discloses a fluorescence detection method that can detect fluorescence emitted from various fluorescent substances used for a cryptograph contained in an object to be inspected.

This fluorescence detection method is a method of detecting fluorescence by irradiating an object to be inspected with excitation light emitted from an excitation light source and causing a spectroscope to receive fluorescence emitted from the object to be inspected due to irradiation with the excitation light, in which a chopper disposed on an optical path connecting the object to be inspected and the spectroscope allows the fluorescence to pass after a predetermined delay time has elapsed from when the excitation light was emitted from the excitation light source and blocks the fluorescence after a predetermined exposure time has elapsed from the passage of the fluorescence.

In the prior art according to JP2017-161929 A and JP2005-091346 A, there has been a problem that light amount measurement cannot be sufficiently handled depending on a state of light emitted from an object.

### SUMMARY

In view of the above circumstances, the present disclosure provides a light amount measuring device and a program that can adjust the amount of light emitted from an object to a light amount corresponding to a measurement range of a light receiving portion.

According to one aspect of the present disclosure, there is provided a light amount measuring device, including: a light emitting portion configured to irradiate an object with excitation light; an optical path through which light emitted from the object passes; a light receiving portion configured to receive the light passing through the optical path; and a shutter disposed on the optical path and configured to switch between an open state that allows passage of the light and a blocked state that does not allow passage of the light, the light amount measuring device being configured to measure a light amount of the light passing through the optical path while repeatedly switching between the open state and the blocked state.

According to such an aspect, the amount of light emitted from the object can be adjusted to the light amount corresponding to the measurement range of the light receiving portion.

### BRIEF DESCRIPTION OF THE DRAWINGS

FIG. 1 is a diagram illustrating an example of the overall configuration of an inspection apparatus 1 according to an embodiment.

FIG. 2 is an exploded perspective view of the inspection apparatus 1 according to the embodiment.

FIG. 3 is an exploded perspective view of the inspection apparatus 1 for explaining a positional relationship among a placement part 2, a temperature control unit 5, a magnetic force applying part 6, and an inspection tool 900.

FIG. 4 is a plan view of a light amount measuring device 200 according to the embodiment.

FIG. 5 is a cross-sectional view of the light amount measuring device 200 taken along A-A shown in FIG. 4.

FIG. 6 is a plan view for explaining an internal configuration of the light amount measuring device 200, with some components of the light amount measuring device 200 omitted.

FIG. 7 is an exploded perspective view of the inspection tool 900 according to the embodiment.

FIG. 8 is a cross-sectional view schematically illustrating the inspection tool 900.

FIGS. 9A-9C are diagrams showing results of simulation of the relationship among an irradiation amount of excitation light by a LED 310, a switching state by a rotary shutter 510, a fluorescence amount of fluorescence from a fluorescent material, and an amount of light received by a PMT 410.

FIG. 10A and 10B are diagrams showing results of simulation of the relationship among an irradiation amount of excitation light by the LED 310, a switching state by the rotary shutter 510, a fluorescence amount of fluorescence from a fluorescent material, and an amount of light received by the PMT 410.

FIG. 11 is a cross-sectional view schematically showing the inspection apparatus 1 including the light amount measuring device 200.

FIG. 12 is a cross-sectional view schematically showing the inspection apparatus 1 including the light amount measuring device 200.

FIG. 13 is a cross-sectional view schematically showing the inspection apparatus 1 including the light amount measuring device 200.

FIG. 14 is a cross-sectional view schematically showing the inspection apparatus 1 including the light amount measuring device 200.

FIG. 15 is a cross-sectional view schematically showing the inspection apparatus 1 including the light amount measuring device 200.

FIG. 16 is a cross-sectional view schematically showing the inspection apparatus 1 including the light amount measuring device 200.

### DETAILED DESCRIPTION

Hereinafter, an embodiment of the present disclosure will be described with reference to drawings. Various features described in the embodiment below can be combined with each other.

A program for implementing software described in one embodiment may be provided as a non-transitory computer-readable storage medium, may be made available for download from an external server, or may be provided in such a manner that the program can be activated on an external computer to implement functions thereof on a client terminal (so-called cloud computing).

In various types of information processing according to one embodiment, an input and an output corresponding to the input can be realized. Here, as long as an output is obtained as a result of the input, the form of information referred to in such information processing (hereinafter referred to as reference information) is not limited. The reference information may be, for example, rule-based information such as a database, a look-up table, a predefined function (including a decision formula such as a regression equation constructed by statistical methods), may be a trained model in which the correlation between an input and an output has been learned in advance, or may be a generative AI such as a large-scale language model or a vision language model that can output a desired result by inputting a prompt.

In one embodiment, the term "unit" may also include, for example, a combination of hardware resources implemented by a circuit in a broad sense, and information processing performed by software that may be specifically implemented by such hardware resources. Furthermore, various kinds of information are handled in one embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

Furthermore, the term “circuit in a broad sense” refers to a circuit that is implemented by appropriately combining at least one or more of a circuit, circuitry, a processor, memory, and the like. The processor may be a general-purpose processor or a dedicated circuit. In other words, the term “circuit in a broad sense” includes an application specific integrated circuit (ASIC), a programmable logic device (e.g., a simple programmable logic device (SPLD), a complex programmable logic device (CPLD), a field programmable gate array (FPGA)), and the like.

### Inspection apparatus 1

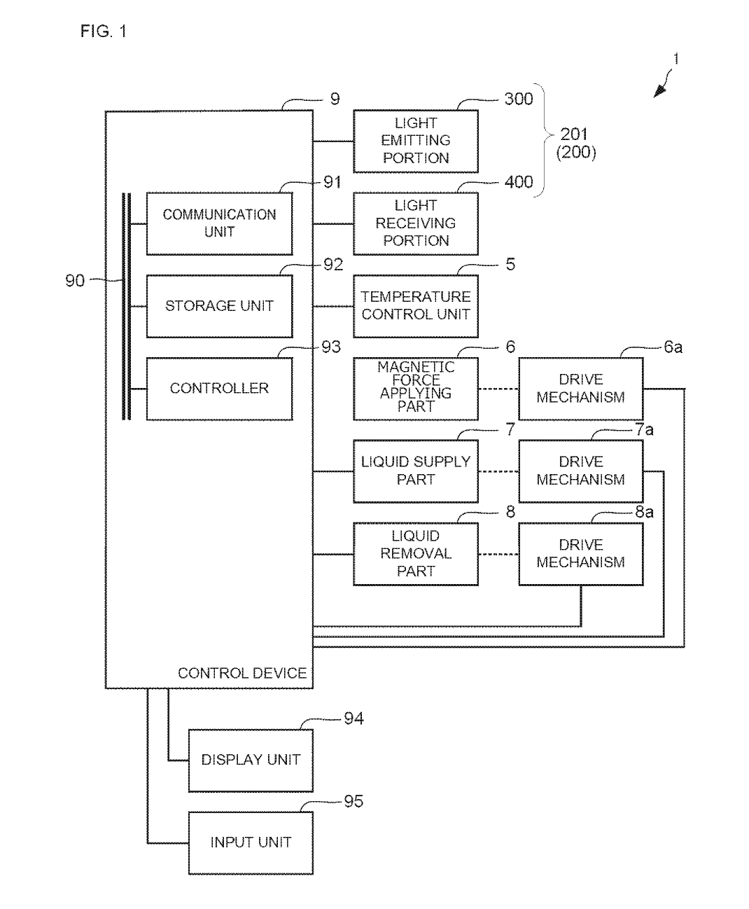

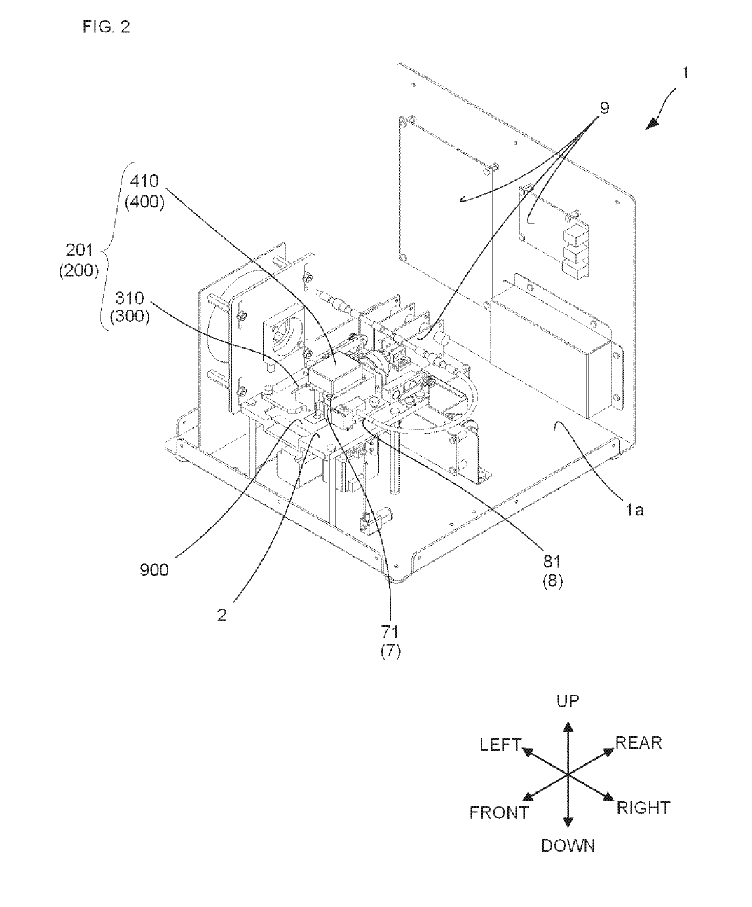

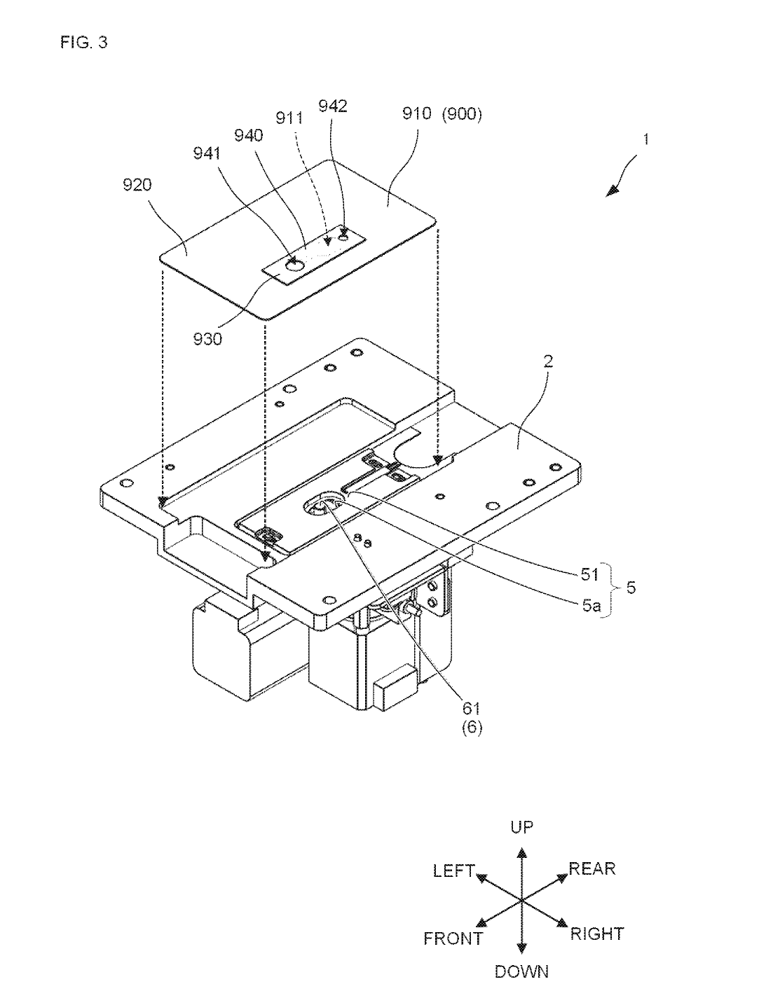

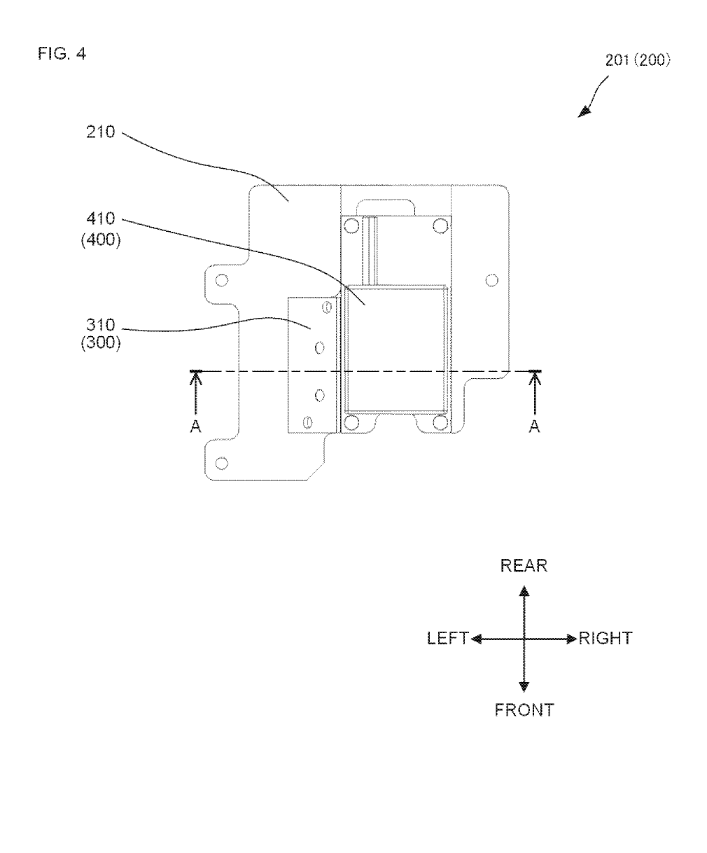

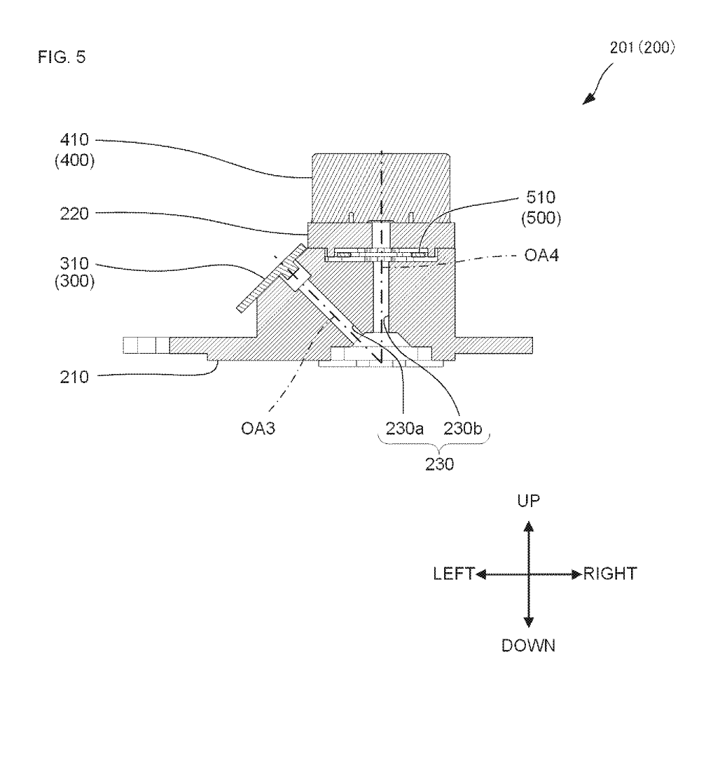

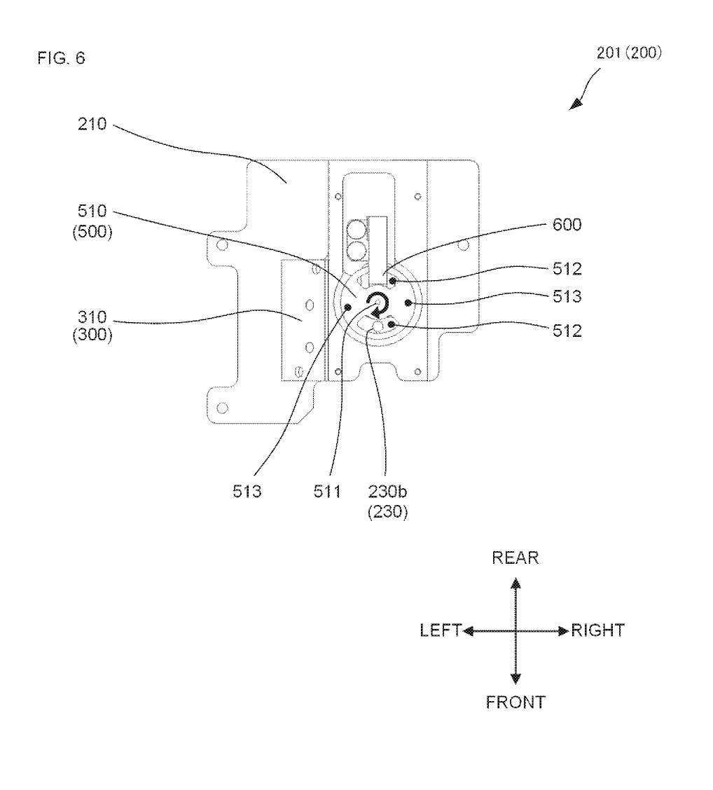

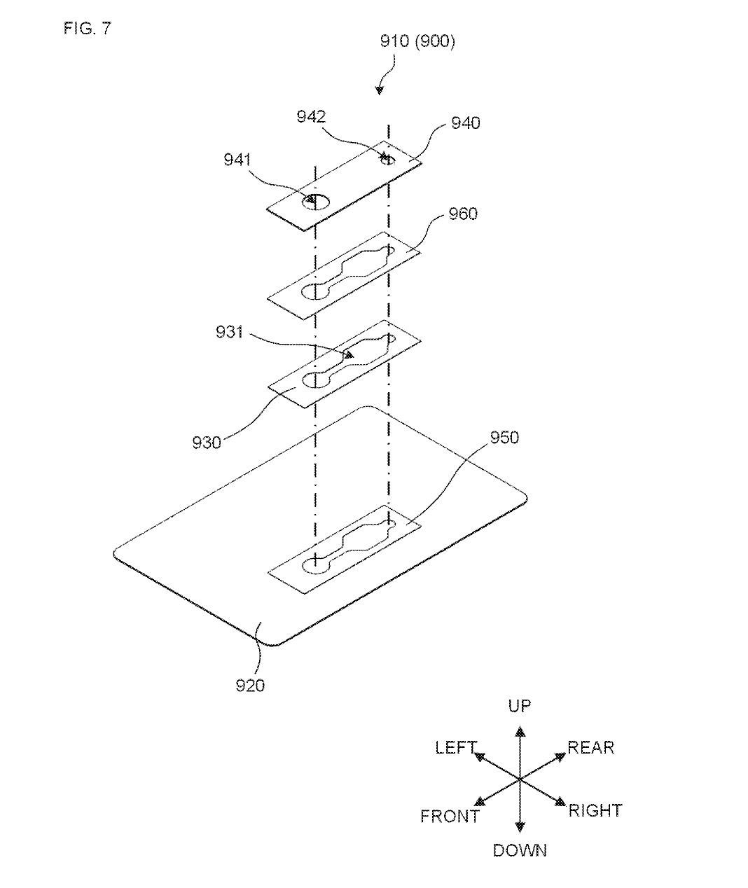

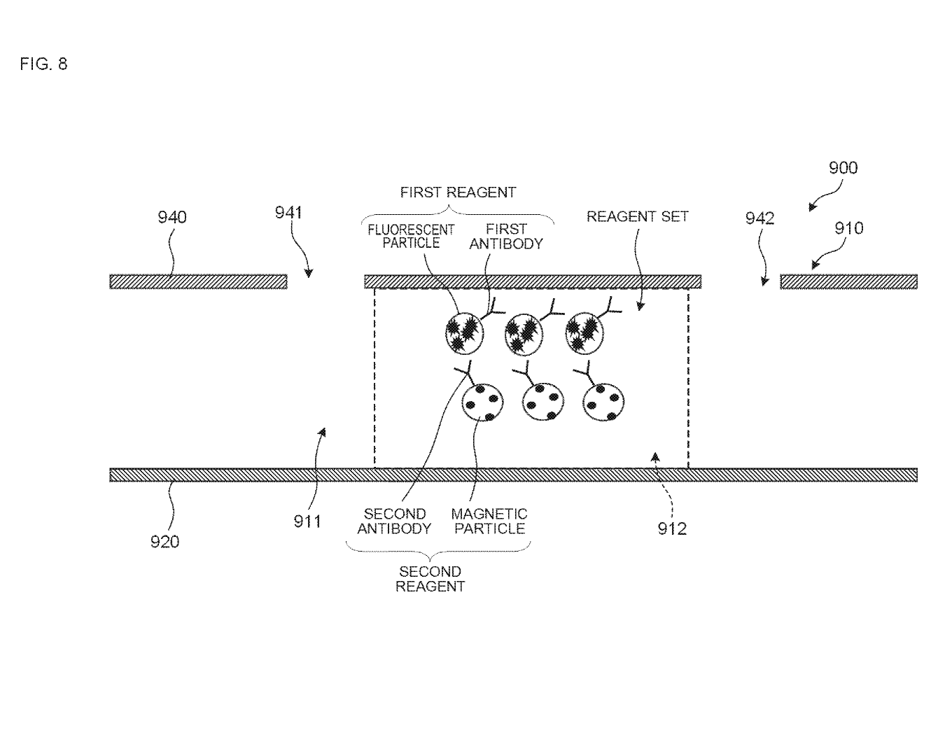

First, an inspection apparatus 1 according to an embodiment will be described. FIG. 1 is a diagram illustrating an example of the overall configuration of the inspection apparatus 1 according to an embodiment. FIG. 2 is an exploded perspective view of the inspection apparatus 1 according to the embodiment. FIG. 3 is an exploded perspective view of the inspection apparatus 1 for explaining a positional relationship among a placement part 2, a temperature control unit 5, a magnetic force applying part 6, and an inspection tool 900. FIG. 4 is a plan view of a light amount measuring device 200 according to the embodiment. FIG. 5 is a cross-sectional view of the light amount measuring device 200 taken along A-A shown in FIG. 4. FIG. 6 is a plan view for explaining an internal configuration of the light amount measuring device 200, with some components of the light amount measuring device 200 omitted. FIG. 7 is an exploded perspective view of the inspection tool 900 according to the embodiment. FIG. 8 is a cross-sectional view schematically illustrating the inspection tool 900.

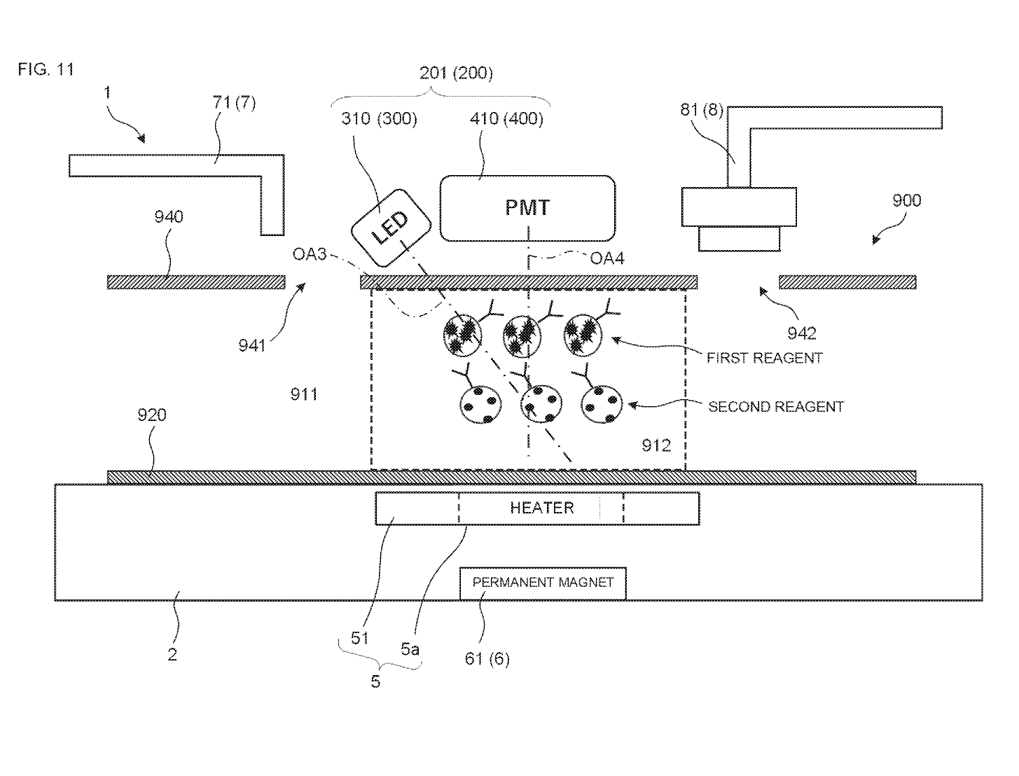

In FIGS. 2- 7, directions of the inspection apparatus 1, the light amount measuring device 200, the inspection tool 900, and each component constituting these are defined based on "up", "down", "left", "right", "front" and "rear" shown in the drawings. In this case, “up” is also referred to as an "upper side" or "upper", and "down” is also referred to as a "lower side" or "lower". The direction formed by “up” and "down” is referred to as the "up-down" or "up-down direction”, and the same applies to "down”, "left", "right", "front," and "rear". Furthermore, in FIG. 8 (and similarly in FIGS. 11-16), the upper side is referred to as “up” or “upper,” and the lower side is referred to as "down” or "lower.”

The inspection apparatus 1 shown in FIG. 1 is used, for example, to quantitatively inspect the antigen concentration in a specimen by setting the inspection tool 900 on the placement part 2. The inspection apparatus 1 includes a case 1a, the placement part 2, the temperature control unit 5, the magnetic force applying part 6, a liquid supply part 7, a liquid removal part 8, a control device 9, a display unit 94, an input unit 95, and the light amount measuring device 200.

### Case 1a

The case 1a is a box that houses mechanical and electrical equipment for inspecting a specimen in the inspection apparatus 1. Inside the case 1a, all or part of the placement part 2, the temperature control unit 5, the magnetic force applying part 6, the liquid supply part 7, the liquid removal part 8, the control device 9, the display unit 94, the input unit 95, and the light amount measuring device 200 are housed. Furthermore, the case 1a includes an opening/closing portion (not shown), and the opening/closing portion may be configured to allow the inspection tool 900 to be inserted into and removed from the inside of the case 1a and to block light outside the case 1a during inspection by the inspection apparatus 1.

### Placement part 2

As shown in FIG. 2, the placement part 2 includes a plate-like member and is configured to mount the inspection tool 900 on the plate-like member. The temperature control unit 5, the magnetic force applying part 6, the liquid supply part 7, the liquid removal part 8, and the light amount measuring device 200 are mechanically connected to the placement part 2.

### Temperature control unit 5

As shown in FIG. 3, the temperature control unit 5 mechanically connected to the placement part 2 is disposed below the placement part 2. The temperature control unit 5 is configured to control the temperature of the inspection tool 900 and may be configured, for example, by combining a heater 51, a thermistor (not shown), and a controller (not shown). Hereinafter, a case where the heater 51, the thermistor, and the controller are adopted in the temperature control unit 5 will be described as an example.

### Magnetic force applying part 6

As shown in FIG. 3, the magnetic force applying part 6 mechanically connected to the placement part 2 is disposed below the placement part 2. The magnetic force applying part 6 is configured to apply a magnetic force to a magnetic material and may be, for example, a permanent magnet 61 or an electromagnet. Hereinafter, a case where the permanent magnet 61 is adopted in the magnetic force applying part 6 will be described as an example.

As shown in FIG. 1, the magnetic force applying part 6 is mechanically connected to a drive mechanism 6a. The drive mechanism 6a is configured to move the magnetic force applying part 6. Specifically, the magnetic force applying part 6 moves within a through hole 5a of the temperature control unit 5 by the drive mechanism 6a, thereby approaching and separating from the inspection tool 900 placed on the placement part 2. That is, the temperature control unit 5 includes the through hole 5a that allows the magnetic force applying part 6 to approach and separate from the inspection tool 900 placed on the placement part 2. The drive mechanism 6a may be configured to move the magnetic force applying part 6 in the up-down direction in which the magnetic force applying part 6 approaches and separates from the inspection tool 900 placed on the placement part 2, and in a front-rear direction orthogonal to the up-down direction.

### Liquid supply part 7

As shown in FIG. 2, the liquid supply part 7 mechanically connected to the placement part 2 is disposed below the placement part 2. The liquid supply part 7 includes a cleaning solution supply nozzle 71, and the cleaning solution supply nozzle 71 is configured to supply a cleaning solution CS to the inspection tool 900.

As shown in FIG. 1, the liquid supply part 7 is mechanically connected to a drive mechanism 7a. The drive mechanism 7a is configured to move the cleaning solution supply nozzle 71 of the liquid supply part 7. Specifically, the cleaning solution supply nozzle 71 is moved by the drive mechanism 7a between a position that allows supply of the cleaning solution CS to the inspection tool 900 placed on the placement part 2 and a position that stops the supply of the cleaning solution CS.

### Liquid removal part 8

As shown in FIG. 2, the liquid removal part 8 mechanically connected to the placement part 2 is disposed below the placement part 2. The liquid removal part 8 includes a removal nozzle 81, and the removal nozzle 81 is configured to remove waste liquid from inside a reaction detection section 912 of the inspection tool 900. Furthermore, the liquid removal part 8 removes the waste liquid from inside the reaction detection section 912 by bringing the inside of the inspection tool 900 into a negative pressure state through the removal nozzle 81. In this case, the liquid removal part 8 may remove the waste liquid from inside the reaction detection section 912 by sucking only air in the inspection tool 900 and moving the waste liquid from inside the reaction detection section 912 to an arbitrary area in the inspection tool 900. Alternatively, the liquid removal part 8 may remove the waste liquid from inside the reaction detection section 912 by sucking air and the waste liquid in the inspection tool 900. Details of the reaction detection section 912 will be described later.

As shown in FIG. 1, the liquid removal part 8 is mechanically connected to a drive mechanism 8a. The drive mechanism 8a is configured to move the removal nozzle 81 of the liquid removal part 8. Specifically, the removal nozzle 81 is moved by the drive mechanism 8a between a position that allows removal of the waste liquid from the inspection tool 900 placed on the placement part 2 and a position that stops the removal of the waste liquid.

### Control device 9

As shown in FIG. 1, the control device 9 includes a communication unit 91, a storage unit 92, and a controller 93, and these components are electrically connected via a communication bus 90. Each component will be further described.

The communication unit 91 is communicable with various hardware configurations included in the inspection apparatus 1 and includes an input/output interface capable of transmitting and receiving various signals to and from the various hardware configurations. The communication unit 91 preferably performs communication using a wired communication means, and may also include wireless communication or the like as necessary. Data communication for executing various inspection steps in the inspection apparatus 1 is performed in a network configured by the communication unit 91.

The storage unit 92 stores various types of information. The storage unit 92 may be implemented, for example, as a storage device such as a solid state drive (SSD) storing programs or the like for executing various inspection steps in the inspection apparatus 1, or as a memory such as a random access memory (RAM) storing temporarily necessary information (arguments, arrays, or the like) pertaining to program operations. The storage unit 92 stores programs, variables, and the like for executing various inspection steps in the inspection apparatus 1.

The controller 93 performs processing and control pertaining to the inspection apparatus 1. The controller 93 includes, for example, an unshown central processing unit (CPU). The controller 93 implements various functions pertaining to the inspection apparatus 1 by reading a predetermined program stored in the storage unit 92. In other words, information processing by software stored in the storage unit 92 can be executed as each function execution unit included in a processor by being specifically realized through the processor, which is an example of hardware. The controller 93 is not limited to being a single unit, and may be implemented with multiple controllers 93 for the individual functions. Moreover, a combination thereof may be acceptable. That is, the inspection apparatus 1 includes the controller 93 that is at least one processor. The controller 93 as a processor is configured to execute inspection steps described later by reading a program. It is preferable that a programmable logic device be adopted as the controller 93, which is a processor. For example, a field programmable gate array (FPGA) or other logic devices may be adopted as the controller 93 according to the present disclosure. In this case, control related to the inspection apparatus 1 can be implemented by re-writable logic circuit control such as an FPGA.

Specifically, the control device 9 acquires, via the communication unit 91, information on various sensors included in the inspection apparatus 1, information input from outside the inspection apparatus 1, and the like. The controller 93 performs various calculation processing using various types of information by reading the program in the storage unit 92. Based on the calculation processing of the controller 93, a control signal for controlling the inspection apparatus 1 is generated, and various devices (sensors, actuators, etc.) operate according to the control signal. Then, the control device 9 outputs obtained information (inspection results, etc.) to the display unit 94 or the like.

### Display unit 94

The display unit 94 is electrically connected to the control device 9 via the communication unit 91 and may be, for example, included in the inspection apparatus 1 or may be externally attached. The display unit 94 is a display device such as a liquid crystal display and an organic EL display and displays a screen of a graphical user interface (GUI) that can be operated by a user.

### Input unit 95

The input unit 95 is electrically connected to the control device 9 via the communication unit 91 and may be included in the inspection apparatus 1 or may be externally attached. For example, the input unit 95 may be implemented as a touchscreen integrated with the display unit 94. If the input unit 95 is a touchscreen, the user can input operations such as tapping, swiping, and the like. Of course, instead of a touchscreen, switch buttons, a mouse, a QWERTY keyboard and the like may be adopted. That is, the input unit 95 accepts an operation input performed by the user. This input is transferred as an instruction signal to the controller 93 via the communication unit 91, and the controller 93 may execute predetermined control or computation as needed.

### Light amount measuring device 200

The light amount measuring device 200 is configured to measure the amount of light emitted from an object by irradiating the object with excitation light. The light emitted from the object is, for example, fluorescence, phosphorescence, or persistent luminescence. Hereinafter, a case where a time-resolved fluorescence measuring device 201 is adopted for the light amount measuring device 200 will be described as an example. In this case, the object includes a fluorescent material, and the time-resolved fluorescence measuring device 201 measures a light amount of fluorescence emitted from the fluorescent material. The time-resolved fluorescence measuring device 201 shown in FIG. 2 is disposed above the placement part 2 and is mechanically connected to the placement part 2. As shown in FIGS. 4-6, the time-resolved fluorescence measuring device 201 includes a light emitting portion 300, a light receiving portion 400, a shutter 500, and a position detection sensor 600.

### Light emitting portion 300

As shown in FIG. 5, the light emitting portion 300 is disposed above a base frame 210 and is configured to emit excitation light so as to pass the light through an optical path 230a (an example of an optical path 230) formed by the base frame 210. Accordingly, the light emitting portion 300 is configured to irradiate the inspection tool 900 placed on the placement part 2 with excitation light. In other words, the time-resolved fluorescence measuring device 201, which is an example of the light amount measuring device 200, includes the light emitting portion 300 that irradiates an object containing a fluorescent material with excitation light. In the time-resolved fluorescence measuring device 201, the light is irradiated from the object by irradiation with the excitation light, and then, a light amount of light emitted from the object while the excitation light is turned off is measured. Further, the light emitting portion 300 included in the time-resolved fluorescence measuring device 201 is configured to repeat irradiation with the excitation light and turning off of the excitation light at an arbitrary timing. The light emitting portion 300 is not particularly limited as long as the light emitting portion 300 can emit the excitation light, and is preferably, for example, an LED 310 (Light Emitting Diode). When the LED 310 is adopted for the light emitting portion 300, the light emitting portion 300 can emit the excitation light at a constant irradiation amount by long-time blinking control. The LED 310 can increase or decrease an irradiation amount by changing the value of the current to be supplied, but when stable irradiation amount is desired, it is preferable to emit light by supplying a constant current. That is, the LED 310 can emit light with a more stable irradiation amount by performing blinking control using a constant current value. As a result, measurement by the time-resolved fluorescence measuring device 201 can be performed more stably. Hereinafter, a case where the LED 310 is adopted for the light emitting portion 300 will be described as an example.

### Light receiving portion 400

As shown in FIG. 5, the light receiving portion 400 is disposed above the base frame 210 and a spacer 220 and is configured to receive fluorescence from the fluorescent material passing through the optical path 230. Specifically, the fluorescence from the fluorescent material is configured to pass through an optical path 230b (an example of the optical path 230) formed by the base frame 210 and the spacer 220, and the light receiving portion 400 is configured to receive the fluorescence that has passed therethrough. In other words, the time-resolved fluorescence measuring device 201, which is an example of the light amount measuring device 200, includes the optical path 230 through which light emitted from an object (a fluorescent material as an example) passes, and the light receiving portion 400 that receives light passing through the optical path 230. The light receiving portion 400 is not particularly limited as long as the light receiving portion 400 can receive fluorescence from the fluorescent material and convert the fluorescence into an electric signal according to the light amount, and may be, for example, a PMT 410 (Photomultiplier Tube) or a PD (Photo Diode) (not shown). Hereinafter, a case where the PMT 410 is adopted for the light receiving portion 400 will be described as an example.

### Shutter 500

As shown in FIG. 5, the shutter 500 is disposed on the optical path 230b (an example of the optical path 230) by being disposed between the base frame 210 and the spacer 220. Furthermore, the shutter 500 is disposed on the optical path 230, and is configured to switch between an open state M1 that allows the passage of fluorescence and a blocked state M2 that does not allow the passage of fluorescence. In other words, the time-resolved fluorescence measuring device 201, which is an example of the light amount measuring device 200, includes the shutter 500 that is disposed on the optical path 230 and that can switch between the open state M1 that allows the passage of light and the blocked state M2 that does not allow the passage of light.

With such a configuration, the time-resolved fluorescence measuring device 201 adjusts the amount of fluorescence from the fluorescent material to a light amount corresponding to the measurement range of the light receiving portion 400 based on irradiation with excitation light by the LED 310 and switching between the open state M1 and the blocked state M2 by the shutter 500. Then, the time-resolved fluorescence measuring device 201 measures, by the PMT 410, a light amount of the fluorescence passing through the optical path 230. In other words, the time-resolved fluorescence measuring device 201, which is an example of the light amount measuring device 200, measures a light amount of light passing through the optical path 230 while repeatedly switching between the open state M1 and the blocked state M2. According to such an aspect, the amount of light emitted from the object can be adjusted to the light amount corresponding to the measurement range of the light receiving portion 400. As a result, the PMT 410 can avoid receiving a light amount exceeding the measurement range of the PMT 410. That is, the PMT 410 can be used under a stable measurement environment for a long period of time.

Furthermore, the shutter 500 shown in FIG. 6 is a rotary shutter 510 that can switch between the open state M1 and the blocked state M2 by rotating. The rotary shutter 510 includes a rotation shaft 511, through holes 512, and a blocking portion 513. In the rotary shutter 510 shown in FIG. 6, the rotation shaft 511 is disposed along the up-down direction, and the through hole 512 and the blocking portion 513 alternately pass over the optical path 230b by rotating about the rotation shaft 511. Accordingly, the rotary shutter 510 (an example of the shutter 500) can switch between the open state M1 and the blocked state M2 by rotating. The shutter 500 is not particularly limited as long as the shutter 500 can switch between the open state M1 and the blocked state M2, and may be, for example, a mechanical shutter such as a slide shutter, or may be a shutter such as an electronic shade or dimming glass that can switch between the open state M1 and the blocked state M2 by electrically changing light transmittance. Hereinafter, a case where the rotary shutter 510 is adopted for the shutter 500 will be described as an example.

In the rotary shutter 510 shown in FIG. 6, two through holes 512 are provided via the rotation shaft 511. That is, the through holes 512 pass over the optical path 230 twice during one rotation of the rotary shutter 510. That is, switching between the open state M1 and the blocked state M2 is performed four times during one rotation of the rotary shutter 510. The number of through holes 512 included in the rotary shutter 510 is not particularly limited, but is preferably about 1 or more and 16 or less, more preferably about 2 or more and 8 or less, and further preferably about 2 or more and 4 or less. Hereinafter, a case where two through holes 512 having the same shape are provided at equal intervals in the circular rotary shutter 510 will be described as an example. When the rotary shutter 510 having such a configuration is adopted, the rotary shutter 510 can stably rotate without vibration during high-speed rotation.

### Position detection sensor 600

The position detection sensor 600 is configured to detect the open state M1 and the blocked state M2. Specifically, the position detection sensor 600 shown in FIG. 6 is configured to detect the through hole 512 and the blocking portion 513 of the rotary shutter 510. That is, the position detection sensor 600 is configured to detect whether the rotational position of the rotary shutter 510 is in the open state M1 or the blocked state M2 by detecting the through hole 512 and the blocking portion 513. Specifically, the position detection sensor 600 is disposed at a position facing the optical path 230b via the rotation shaft 511 of the rotary shutter 510 in a plane defined by the front-rear and left-right directions. Since two through holes 512 having the same shape are arranged at equal intervals in the rotary shutter 510, the position detection sensor 600 detects the through hole 512 of the rotary shutter 510 in the open state M1 and detects the blocking portion 513 in the blocked state M2. The position detection sensor 600 is not particularly limited as long as the position detection sensor 600 can detect the open state M1 and the blocked state M2, and may be, for example, an inductive type, a magnetostrictive type, or an optical type position detection sensor 600. When the optical type position detection sensor 600 is used, the open/closed state of the shutter 500 is determined by light emitted from the position detection sensor 600. The light becomes disturbance light (optical noise) when the PMT 410 measures a fluorescence amount. Therefore, when the optical type position detection sensor 600 is used, it is preferable to perform control so that no light is emitted from the position detection sensor 600 during measurement of the fluorescence amount by the PMT 410. When a stepping motor is used for a drive mechanism of the rotary shutter 510, the information on a boundary between the through hole 512 and the blocking portion 513 of the rotary shutter 510 (that is, a shape of the rotary shutter 510) and the information on the rotational position by the stepping motor may be grasped in association with each other. Specifically, before the time-resolved fluorescence measuring device 201 measures the light amount of fluorescence, the rotary shutter 510 is rotated at least once, and switching between the open state M1 and the blocked state M2 accompanying rotation of the rotary shutter 510 is detected by the position detection sensor 600. The information on the detected switching between the open state M1 and the blocked state M2 and the information on the rotational position by the stepping motor are grasped in association with each other. When the time-resolved fluorescence measuring device 201 is measuring the light amount of fluorescence, the open state M1 and the blocked state M2 are detected based on the information on the rotational position by the stepping motor. The position detection sensor 600 that grasps the boundary between the through hole 512 and the blocking portion 513 of the rotary shutter 510 may be an inductive type, a magnetostrictive type, or an optical type position detection sensor.

### Inspection tool 900

Next, the inspection tool 900 according to an embodiment will be described. The inspection tool 900 according to the embodiment is used when quantitatively inspecting an antigen concentration in a specimen by being set on the placement part 2 of the inspection apparatus 1.

The inspection tool 900 shown in FIG. 3 includes an inspection tool main body 910 in which a chamber 911 is defined, and a liquid supply port 941 and a liquid suction port 942 that are provided in the inspection tool main body 910 and communicate with the chamber 911.

In the inspection tool main body 910, a transparent cover 940 is joined to a dark (black) or transparent base 920 via a transparent spacer 930. In an embodiment, each of the base 920, the spacer 930, and the cover 940 has a flat plate shape, and the inspection tool main body 910 also has, as a whole, a flat plate shape (card shape).

The base 920 is formed of a large plate material. The thickness of the base 920 is not particularly limited, but is preferably about 0.1 mm or more and 2.0 mm or less, more preferably about 0.2 mm or more and 1.0 mm or less, and further preferably about 0.225 mm or more and 0.275 mm or less.

The constituent material of the base 920 (the spacer 930, the cover 940) is not particularly limited, and examples include various resin materials such as polyethylene terephthalate (PET), polyethylene (PE), polycarbonate (PC), cycloolefin polymer (COP), cycloolefin copolymer (COC), and polymethyl methacrylate (PMMA), and various ceramics materials.

As shown in FIG. 7, the spacer 930 is formed of a small plate material, and a through hole 931 having a predetermined shape is formed in the central portion of the spacer 930. When the base 920, the spacer 930, and the cover 940 are overlaid on each other, the through hole 931 is closed by the base 920 and the cover 940, and the chamber 911 is defined. The thickness of the spacer 930 is not particularly limited, but is preferably about 0.025 mm or more and 0.5 mm or less, more preferably about 0.05 mm or more and 0.25 mm or less, and further preferably about 0.0675 mm or more and 0.0875 mm or less. Thus, the chamber 911 having a sufficiently small capacity can be defined.

The capacity of the chamber 911 is not particularly limited, but is preferably about 5.0 mm³ or more and 50.0 mm³ or less, more preferably about 10.0 mm³ or more and 40.0 mm³ or less, and further preferably about 20.0 mm³ or more and 30.0 mm³ or less.

As shown in FIG. 8, the chamber 911 includes a reaction detection section 912 that is provided in a portion thereof and accommodates the reagent set described above. In the reaction detection section 912, the reagent set reacts with an antigen in the specimen. Details of the reagent set will be described later.

As shown in FIG. 7, the cover 940 is formed of a small plate material having the same thickness and the same constituent material as the spacer 930, and includes a liquid supply port 941 and a liquid suction port 942 formed as two circular through holes spaced apart from each other. Then, in a state where the base 920, the spacer 930, and the cover 940 are overlaid on each other, the liquid supply port 941 and the liquid suction port 942 each communicate with the chamber 911.

For example, a liquid such as a specimen, a sample obtained by diluting the specimen with a diluent, or a cleaning solution is supplied to the chamber 911 (the reaction detection section 912) via the liquid supply port 941. On the other hand, a liquid such as waste liquid is removed from the chamber 911 (the reaction detection section 912) via the liquid suction port 942.

As shown in FIG. 7, the base 920 and the spacer 930 are bonded by an adhesive sheet 950, and the spacer 930 and the cover 940 are bonded by an adhesive sheet 960. Each of the adhesive sheets 950 and 960 has the same as or a similar shape to the spacer 930.

Examples of each adhesive sheet 950, 960 (double-sided adhesive tape) include a double-sided adhesive tape, having a thickness of 0.05 mm or more and 0.2 mm or less, of an anaerobic adhesive such as an acrylic adhesive, or a double-sided adhesive tape of a thermosetting adhesive such as an epoxy adhesive, a melamine adhesive, or a phenolic adhesive.

### Reagent set

A reagent set according to an embodiment is in a dry state and includes a first reagent and a second reagent.

The reagent set includes fluorescent particles (an example of a fluorescent material), and for example, the first reagent includes fluorescent particles on which a first antibody that recognizes an antigen is immobilized, and the second reagent includes magnetic particles on which a second antibody that recognizes an epitope of the antigen different from the first antibody is immobilized.

Each of the components will be described below in sequence.

### Antigens

As the antigen, various substances to be detected can be selected, and examples thereof include: coagulation/fibrinolysis markers such as fibrin degradation products (e.g., D-dimer), soluble fibrin, fibronectin, TAT and PIC; tumor markers such as CA19-9, CA125, and PSA; circulation-related markers such as oxidized LDL and BNP; metabolism-related markers such as adiponectin; inflammation-related markers such as CRP, IgA, IgG, and IgM; infection-related markers such as influenza, HBV, HCV, HIV, Toxoplasma, Chlamydia, and syphilis; allergen-specific IgE; hormones; drugs; nucleic acids and fragments thereof related to SNPs; lipids; and sugars.

### Fluorescent particles

The fluorescent particles, which are an example of the fluorescent material, are particles labeled with a fluorescent substance, and may be particles containing a fluorescent substance therein or particles carrying a fluorescent substance on a surface thereof. Specific examples of the fluorescent particles include fluorescent resin particles containing a fluorescent substance therein and fluorescent silica particles carrying the fluorescent substance on the surface thereof. Examples of usable resins include polystyrene, polyamide, polyacrylonitrile, poly-p-xylylene, phenolic resin, and the like.

An average particle diameter of the fluorescent particles is not particularly limited, but is preferably about 70 nm or more and 500 nm or less, more preferably about 70 nm or more and 300 nm or less, further preferably about 80 nm or more and 250 nm or less, and particularly preferably about 90 nm or more and 200 nm or less. In the present specification, the average particle diameter means a particle diameter (D50) at which a frequency reaches 50% when a particle amount is cumulatively calculated from a small particle diameter side in a particle distribution measured by a dynamic light scattering method.

Examples of the fluorescent substance include europium(III), terbium(III), samarium(III), dysprosium(III), and the like. These fluorescent substances may be used alone, or in combination of two or more thereof. Among these, europium(III) is preferable as the fluorescent substance because it has a long fluorescence half-life. Europium(III) emits fluorescence with a long wavelength (approximately 610 nm) when irradiated with excitation light having a wavelength of approximately 340 nm. This fluorescence peak is sufficiently separated from the excitation light peak.

The fluorescent particles may be composed of the fluorescent substance alone.

### First antibody

The first antibody may be any type of immunoglobulin molecule, and may be an immunoglobulin molecule fragment having an antigen-binding site such as a Fab fragment. Furthermore, the first antibody may be either a monoclonal antibody or a polyclonal antibody.

The first antibody can be directly bound to the fluorescent particles by using a physical adsorption method, a chemical bonding method, or the like, and can also be indirectly bound to the fluorescent particles via, for example, ligand-anti-ligand binding such as avidin-biotin binding, glutathione-glutathione S-transferase binding, or 1-(3-dimethylaminopropyl)-3-ethylcarbodiimide (EDC)-N-hydroxysuccinimide (NHS) binding.

### Magnetic particles

The magnetic particles are particles containing a magnetic material, and may be particles containing a magnetic material therein or particles carrying a magnetic material on the surface thereof. Specific examples of the magnetic particles include particles containing a magnetic material therein, and particles carrying a magnetic material on the surface thereof. Specific examples of the magnetic particles include magnetic resin particles containing a magnetic material therein, and magnetic silica particles carrying a magnetic material on the surface thereof. Examples of usable resins include polystyrene, polyamide, polyacrylonitrile, poly-p-xylylen, phenolic resin, and the like.

Examples of magnetic materials include magnetite, hematite, ferrite, nickel oxide, cobalt iron oxide, carbon steel, tungsten steel, and the like. The magnetic particles may be composed solely of these magnetic materials.

The average particle diameter of the magnetic particles is not particularly limited, but is preferably about 70 nm or more and 500 nm or less, more preferably about 70 nm or more and 400 nm or less, further preferably about 80 nm or more and 300 nm or less, and particularly preferably about 90 nm or more and 250 nm or less. With the magnetic particles having such an average particle diameter, aggregation thereof is easily prevented.

### Second antibody

The second antibody is an antibody capable of recognizing an epitope of the antigen different from that of the first antibody. The second antibody may also be any type of immunoglobulin molecule, and may be an immunoglobulin molecule fragment having an antigen-binding site such as a Fab fragment. The second antibody may be a monoclonal antibody or a polyclonal antibody.

The second antibody can be directly bound to the magnetic particles using a physical adsorption method, a chemical binding method, or the like, or can also be indirectly bound to the magnetic particles via, for example, ligand-anti-ligand binding such as avidin-biotin binding, glutathione-glutathione S-transferase binding, EDC-NHS binding, and the like.

### Manufacturing method of inspection tool

A manufacturing method of an inspection tool according to an embodiment is a method of manufacturing the inspection tool 900 as described above. The manufacturing method of the inspection tool includes: a preparation step (a first step) of preparing the inspection tool main body 910 and a reagent set; a dispersion liquid preparation step (a second step) of preparing a dispersion liquid in which the reagent set is dispersed; a hydrophilization treatment step of performing a hydrophilization treatment in the chamber 911; a filling step (a third step) of filling the dispersion liquid at least into the reaction detection section 912 in the chamber 911; a freeze-drying step (a fourth step) of freeze-drying the dispersion liquid to accommodate the reagent set in the reaction detection section 912; and a packaging step of aluminum-packaging the obtained inspection tool 900.

The buffer solution used to prepare the dispersion liquid is not particularly limited as long as the buffer solution has a buffering action in a range of pH = 6.0 or more and 8.0 or less. Examples include 10 mM HEPES-NaOH (pH=7.35) and 10 mM Tris-HCl (pH=7.5).

The dispersion liquid preferably further contains sucrose and a sucrose fatty acid ester. The sucrose concentration in the dispersion liquid is not particularly limited, but is preferably about 0.1% (W/V) or more and 20.0% (W/V) or less, and particularly preferably about 0.2% (W/V) or more and 15.0% (W/V) or less.

Examples of the sucrose fatty acid ester include sucrose stearate, sucrose palmitate, sucrose oleate, sucrose laurate, and the like. The concentration of the sucrose fatty acid ester in the dispersion liquid is not particularly limited, but is preferably about 10 μg/μL or more and 500 μg/μL or less, and particularly preferably about 20 μg/μL or more and 350 μg/μL or less.

The dispersion liquid may be obtained by preparing a first dispersion liquid in which the first reagent is dispersed and a second dispersion liquid in which the second reagent is dispersed, and mixing the first dispersion liquid and the second dispersion liquid.

Furthermore, prior to filling the dispersion liquid into the chamber 911 (i.e., between the dispersion liquid preparation step (the second step) and the filling step (the third step)), the manufacturing method includes a hydrophilization treatment step of performing a hydrophilization treatment in the chamber 911 by adding an aqueous solution in which a surfactant is dissolved from the liquid supply port 941 and removing the aqueous solution from the liquid suction port 942. A nonionic surfactant is preferably used as the surfactant.

Examples of the nonionic surfactant include polyoxyethylene alkylphenyl ether, polyoxyalkylene alkyl ether, polyoxyethylene alkyl ether, polyoxyethylene polycyclic phenyl ether, sorbitan fatty acid ester, fatty acid alkanolamide, and the like.

The concentration of the nonionic surfactant in the aqueous solution is preferably about 0.1% (W/V) or more and 1.0% (W/V) or less, and particularly preferably about 0.3% (W/V) or more and 0.7% (W/V) or less.

A freezing method is not particularly limited. Examples of the freezing method include general methods such as a method in which, after the dispersion liquid is dispensed into the chamber 911 from the liquid supply port 941, the inspection tool main body 910 is stored for a whole day and night in a freezer maintained at -30° C or lower to be frozen, or a method in which the inspection tool main body 910 is set in a freeze dryer with a shelf temperature of -30° C or lower and is stored for a whole day and night to be frozen.

A freeze-drying method of the frozen inspection tool main body 910 is not particularly limited. Examples of the freeze-drying method include a method of obtaining the inspection tool 900 by linearly increasing the temperature of the frozen inspection tool main body 910 from -30° C to -20° C in 24 hours in a vacuum state, then linearly raising the temperature from -20° C to 30° C in 20 hours, finally maintaining the temperature at 30° C for 3 hours, and then releasing the vacuum with nitrogen gas.

The inspection tool 900 after freeze-drying is preferably immediately sealed with an aluminum film in a dehumidified environment. The dehumidified environment is not particularly limited, but is preferably an environment in which a relative humidity is about 35% or less in a temperature range of about 22° C or more and 27° C or less. The specifications of the aluminum film are not particularly limited, but a five-layer aluminum film (thickness: 86 μm) in which a polyester film (thickness: 12 μm), a polyethylene film (thickness: 15 μm), an aluminum foil (thickness: 9 μm), a polyethylene film (thickness: 20 μm), and a polyethylene film (thickness: 30 μm) are bonded with an AC coating agent is preferable. The entire inspection tool 900 is wrapped with the aluminum film and sealed by heat sealing. The inspection tool 900 is preferably stored in a sealed state and refrigerated until it is used for inspection.

### Measurement method using time-resolved fluorescence measuring device 201

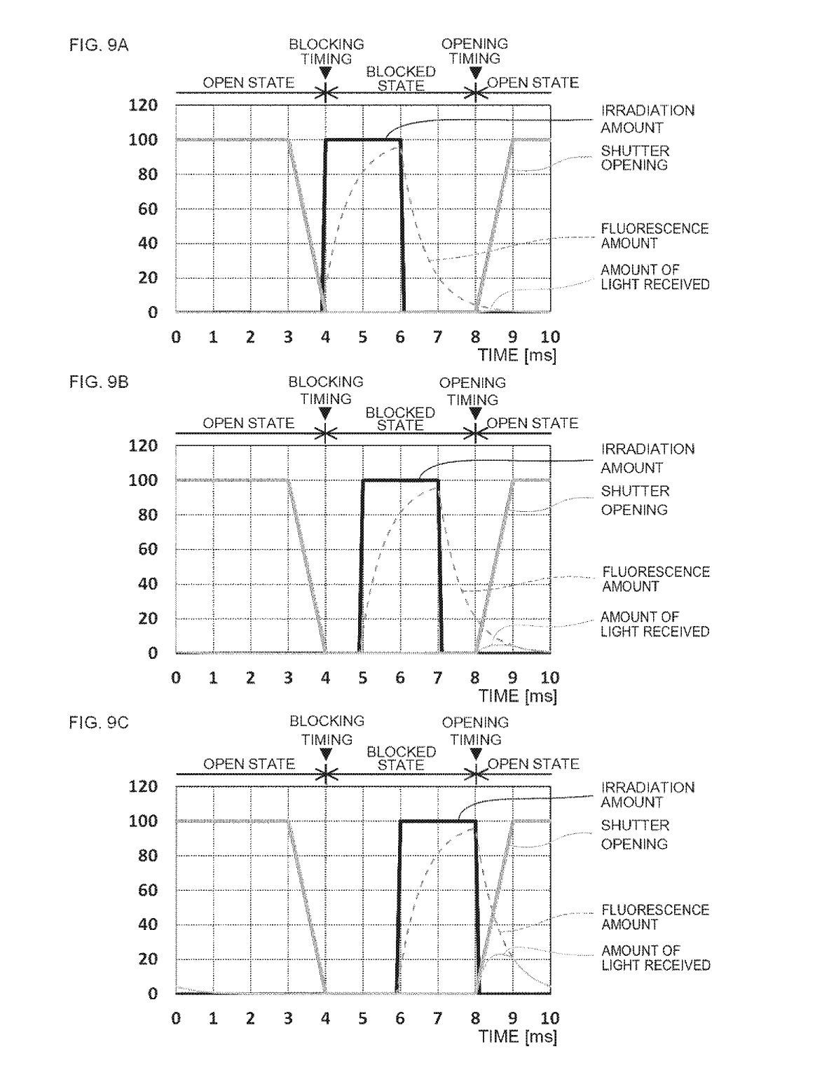

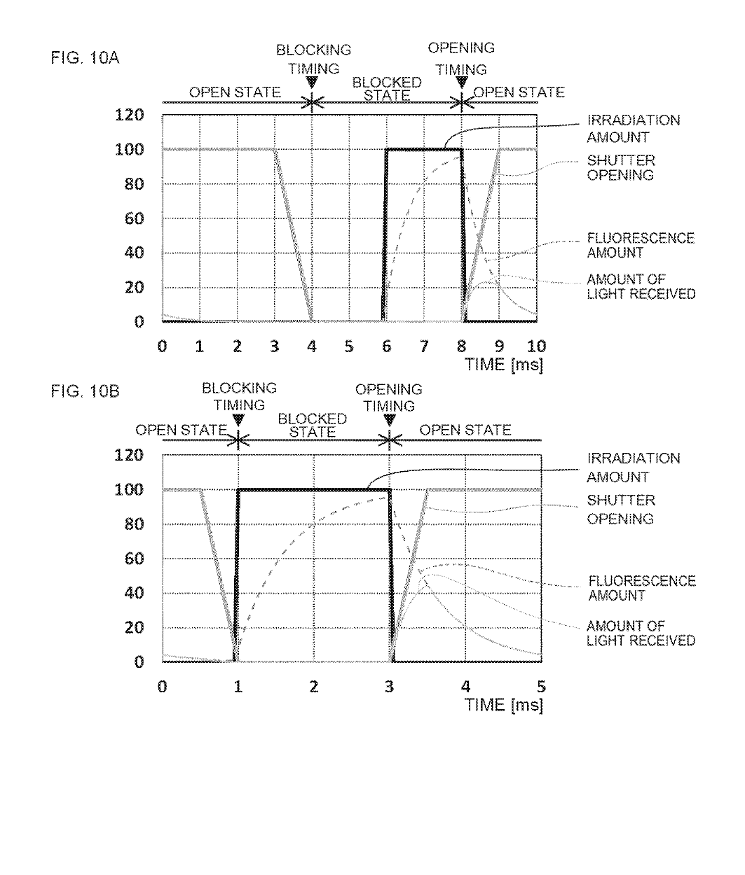

Next, the measurement method using the time-resolved fluorescence measuring device 201 will be described with reference to other drawings. FIGS. 9A-9C, 10A and 10B are diagrams showing results of simulation of the relationship among an irradiation amount of excitation light by the LED 310, a switching state by the rotary shutter 510, a fluorescence amount of fluorescence from a fluorescent material, and an amount of light received by the PMT 410. Hereinafter, the measurement method using the time-resolved fluorescence measuring device 201 will be described using the simulation results. Although the fluorescence amount of fluorescence from the fluorescent material and the amount of light received by the PMT 410 are much smaller than the irradiation amount of excitation light by the LED 310, it should be noted that in the simulation results shown in FIGS. 9A-9C, 10A and 10B, scales are adjusted so as to be comparable.

First, the simulations shown in FIGS. 9A-9C will be described. The simulation shown in each of FIGS. 9A-9C shows a half rotation (=10 ms) when the rotation speed of the rotary shutter 510 is 20 ms per rotation. Furthermore, the horizontal axis indicates time [ms], and the vertical axis indicates the irradiation amount of excitation light [-], the shutter opening [%], the fluorescence amount of fluorescence from the fluorescent material [-], and the amount of light received by the PMT 410 [-]. Note that the lines corresponding to the irradiation amount of excitation light, the fluorescence amount of fluorescence from the fluorescent material, and the amount of light received by the PMT 410 show temporal changes in light intensity, and the respective light amounts are values obtained by integrating the light intensity with respect to time.

The rotary shutter 510 is in the open state M1 during a time from 0 ms to 4 ms, is in the blocked state M2 during a time from 4 ms to 8 ms, and is in the open state M1 during a time from 8 ms to 10 ms.

In this case, the timing of switching from the open state M1 to the blocked state M2 (hereinafter, also referred to as a "blocking timing Tc") is the timing at which passage of fluorescence is gradually blocked as the rotary shutter 510 rotates and thereafter all passage of fluorescence is blocked, which is the timing of 4 ms in the simulation of each of FIGS. 9A-9C. In other words, the blocking timing Tc is a timing of switching the rotary shutter 510 (an example of the shutter 500) from the open state M1 to the blocked state M2.

The timing of switching from the blocked state M2 to the open state M1 (hereinafter, also referred to as an "opening timing To") is the timing at which passage of fluorescence is allowed as the rotary shutter 510 rotates, which is the timing of 8 ms in the simulation of each of FIGS. 9A-9C. In other words, the opening timing To is a timing of switching the rotary shutter 510 (an example of the shutter 500) from the blocked state M2 to the open state M1. The blocking timing Tc and the opening timing To can be arbitrarily defined. The blocking timing Tc may be a timing at which blocking of passage of fluorescence starts or a timing at which passage of fluorescence is blocked at an arbitrary ratio, and the opening timing To may be a timing at which passage of fluorescence is entirely allowed or a timing at which passage of fluorescence is allowed at an arbitrary ratio.

The excitation light to be irradiated by the LED 310 is irradiated at different timings respectively in the simulations shown in FIGS. 9A-9C. Specifically, in the simulation shown in FIG. 9A, the excitation light is set to be irradiated for a time period of 4 ms to 6 ms (hereinafter, referred to as "setting A"). In the simulation shown in FIG. 9B, the excitation light is set to be irradiated for a time period of 5 ms to 7 ms (hereinafter, referred to as "setting B"). In the simulation shown in FIG. 9C, the excitation light is set to be irradiated for a time period of 6 ms to 8 ms (hereinafter, referred to as "setting C").

That is, the excitation light to be irradiated by the LED 310 is irradiated for an irradiation time of 2ms at any arbitrary timing during the time in which the shutter is in the blocked state M2. The arbitrary timing is defined by an irradiation start timing Tis, which is a timing at which the LED 310 starts irradiation with the excitation light, and an irradiation end timing Tit, which is a timing at which the LED 310 ends the irradiation. In other words, the LED 310, which is an example of the light emitting portion 300, starts irradiation with the excitation light at the irradiation start timing Tis and ends irradiation with the excitation light at the irradiation end timing Tit.

Furthermore, although the irradiation timings of the excitation light irradiated by the LED 310 are different among settings A to C, the irradiation amount is constant because irradiation at the same intensity continues for the same period of time. In other words, the LED 310, which is an example of the light emitting portion 300, may emit excitation light at a constant irradiation amount. According to such an aspect, irradiation with the excitation light by the LED 310 can be stabilized. Note that, in the simulations shown in FIGS. 9A-9C, the fluorescence amount of fluorescence from the fluorescent material is also constant by setting the excitation light irradiated to the fluorescent material to a constant irradiation amount.

Each amount of light received by the PMT 410 in the simulations shown in FIGS. 9A-9C are as follows. The amount of light received in setting B shown in FIG. 9B is approximately five times the amount of light received in setting A shown in FIG. 9A as a reference. The amount of light received in setting C shown in FIG. 9C is approximately twenty times the amount of light received in setting A shown in FIG. 9A as a reference. That is, the amount of light received in setting A shown in FIG. 9A is the smallest, the amount of light received in setting C shown in FIG. 9C is the largest, and the amount of light received in setting B shown in FIG. 9B is the amount of light received between setting A and setting C. That is, the amount of light received by the PMT 410 can be adjusted by changing the irradiation end timing Tit while the excitation light is irradiated at a constant irradiation amount. Furthermore, the irradiation end timing Tit may be defined with the opening timing To as a reference. According to such an aspect, by adjusting the irradiation end timing Tit, the amount of fluorescence from the fluorescent material can be adjusted to a light amount corresponding to the measurement range of the light receiving portion 400. Note that results of the simulations shown in FIGS. 9A-9C are examples of results under arbitrary conditions, and the values of the amount of light received, the ratios of the amount of light received, and the like may differ depending on the type of fluorescent material, the configuration of the time-resolved fluorescence measuring device 201, the control settings, and the like. Furthermore, since an appropriate control cycle, the values of the amount of light received, the ratios of the amount of light received, and the like may differ depending on the type of fluorescent material, the control according to the type of fluorescent material is preferably performed.

Further, in setting C shown in FIG. 9C, each of the irradiation end timing Tit and the opening timing To is the timing of 8 ms. Further, as described above, the amount of light received in setting C shown in FIG. 9C is larger than those in settings A and B. That is, when the amount of fluorescence from the fluorescent material is small, the irradiation end timing Tit may be substantially simultaneous with the opening timing To. According to such an aspect, it is possible to increase the amount of light passing through the optical path 230 by performing irradiation with the excitation light up to the timing substantially simultaneously with the opening timing To. As a result, when the amount of fluorescence from the fluorescent material is small, the amount of fluorescence from the fluorescent material can be adjusted to a light amount corresponding to the measurement range of the light receiving portion 400. Note that, in the simulation shown in FIG. 9C, the irradiation end timing Tit and the opening timing To are simultaneous at the timing of 8 ms, but may have a slight time difference. In this case, the time difference is, for example, preferably 0.01 ms or more and 0.5 ms or less, more preferably 0.03 ms or more and 0.3 ms or less, and still more preferably 0.05 ms or more and 0.1 ms or less. Specifically, for example, the time difference is 0.01, 0.02, 0.03, 0.04, 0.05, 0.06, 0.07, 0.08, 0.09, 0.1, 0.15, 0.2, 0.25, 0.3, 0.35, 0.4, 0.45, or 0.5 ms, and may be within a range between any two of the numerical values exemplified herein. Furthermore, the relationship between the irradiation end timing Tit and the opening timing To may be appropriately defined based on the irradiation characteristics such as a response speed of the LED 310, the shapes of the shutter 500 and the optical path 230, the switching speed of the shutter 500, a method of defining the opening timing To, and the like.

Further, in setting A shown in FIG. 9A, the irradiation end timing Tit is a timing that precedes the opening timing To by 2 ms, and in setting B shown in FIG. 9B, the irradiation end timing Tit is a timing that precedes the opening timing To by 1 ms. In other words, when the amount of fluorescence from the fluorescent material is large, the irradiation end timing Tit may be a timing that precedes the opening timing To by an arbitrary time. Further, the irradiation end timing Tit may be a timing that precedes the opening timing To by a longer time as the amount of fluorescence from the fluorescent material increases. According to such an aspect, when the amount of fluorescence from the fluorescent material is large, the amount of fluorescence from the fluorescent material can be adjusted to the light amount corresponding to the measurement range of the light receiving portion 400. The arbitrary time in this case may be arbitrarily set according to the time of the blocked state M2, the characteristics of the switching speed of the shutter 500, and the like. Specifically, for example, the arbitrary time is 0.5, 0.75, 1, 1.25, 1.5, 1.75, 2, 2.25, 2.5, 2.75, 3, 3.25, 3.5, 3.75, 4, 4.25, 4.5, 4.75, or 5 ms, and may be within a range between any two of the numerical values exemplified herein.

Next, the simulations shown in FIGS. 10A and 10B will be described. In the simulations shown in FIGS. 10A and 10B, FIG. 10A shows a half rotation (= 10 ms) when the rotation speed of the rotary shutter 510 is 20 ms per rotation, and FIG. 10B shows a half rotation (= 5 ms) when the rotation speed of the rotary shutter 510 is 10 ms per rotation. Furthermore, the horizontal axis indicates time [ms], and the vertical axis indicates the irradiation amount of excitation light [-], the shutter opening [%], the fluorescence amount of fluorescence from the fluorescent material [-], and the amount of light received by PMT 410 [-]. Note that the lines corresponding to the irradiation amount of excitation light, the fluorescence amount of fluorescence from the fluorescent material, and the amount of light received by the PMT 410 show temporal changes in light intensity, and the respective light amounts are values obtained by integrating the light intensity with respect to time.

FIG. 10A shows the simulation shown in FIG. 9C. That is, the simulation of FIG. 10A is setting C.

In the simulation shown in FIG. 10B, the rotary shutter 510 is in the open state M1 in a time period of 0 ms to 1 ms, is in the blocked state M2 in a time period of 1 ms to 3 ms, and is in the open state M1 in a time period of 3 ms to 5 ms.

In the simulation shown in FIG. 10B, the excitation light is set to be irradiated for a time period of 1 ms to 3 ms (hereinafter, referred to as "setting D"). Furthermore, the irradiation amount of the excitation light irradiated by the LED 310 is constant even in setting D because the irradiation with the same intensity as in settings A to C continues for the same period of time. That is, in the simulations shown in FIGS. 9A-9C and the simulations shown in FIGS. 10A and 10B, the fluorescence amount of fluorescence from the fluorescent material is also constant by setting the excitation light irradiated to the fluorescent material to a constant irradiation amount.

In the simulation shown in FIG. 10A and the simulation shown in FIG. 10B, the switching time TS, which is a time required for switching between the open state M1 and the blocked state M2, is different because the rotation speed of the rotary shutter 510 is different. Specifically, the simulation shown in FIG. 10A requires the switching time TS of 1 ms. Furthermore, the simulation shown in FIG. 10B requires the switching time TS of 0.5 ms.

The amounts of light received by the PMT 410 in the simulations shown in FIGS. 10A and 10B are as follows. The amount of light received in setting D shown in FIG. 10B is approximately 2.8 times the amount of light received in setting C shown in FIG. 10A as a reference. That is, the amount of light received in setting D shown in FIG. 10B is larger than the amount of light received in setting C shown in FIG. 10A. The change in the amount of light received due to changing the settings is such that, with setting A as a reference, setting B receives approximately five times the amount of light received, setting C receives approximately twenty times the amount of light received, and setting D receives approximately fifty-six times the amount of light received. That is, the amount of light received by the PMT 410 can be further adjusted by changing the switching time TS while emitting excitation light at a constant irradiation amount. In other words, the rotary shutter 510 (an example of the shutter 500) may repeatedly switch between the open state M1 and the blocked state M2 at an arbitrarily set switching time TS. In this case, the switching time TS is the time required to switch from the blocked state M2 to the open state M1. According to such an aspect, the amount of fluorescence from the fluorescent material can be further adjusted to the light amount corresponding to the measurement range of the PMT 410 by the switching time TS. Note that the results of the simulations shown in FIGS. 10A and 10B are examples of the results under arbitrary conditions, and the values of the amount of light received, the ratios of the amount of light received, and the like may differ depending on the type of fluorescent material, the configuration of the time-resolved fluorescence measuring device 201, the control settings, and the like. Furthermore, since an appropriate control cycle, the values of the amount of light received, the ratios of the amount of light received, and the like may differ depending on the type of fluorescent material, the control according to the type of fluorescent material is preferably performed.

Furthermore, in the case of the rotary shutter 510, the switching time TS is the time determined depending on the rotation speed of the shutter 500. That is, the switching time TS may be changed by the rotation speed of the rotary shutter 510. According to such an aspect, the switching time TS is changed by changing the rotation speed of the rotary shutter 510, and as a result, the amount of fluorescence from the fluorescent material can be adjusted to the light amount corresponding to the measurement range of the light receiving portion 400.

Furthermore, the switching time TS may include a first switching time TS1 and a second switching time TS2. Specifically, in the simulation shown in FIG. 10A, the switching time TS is set to 1 ms as the first switching time TS1, and in the simulation shown in FIG. 10B, the switching time TS is set to 0.5 ms as the second switching time TS2. That is, the first switching time TS1 is longer than the second switching time TS2. The rotary shutter 510 (an example of the shutter 500) may repeatedly switch between the open state M1 and the blocked state M2 at the first switching time TS1 or the second switching time TS2. According to such an aspect, based on the first switching time TS1 and the second switching time TS2, the amount of fluorescence from the fluorescent material can be adjusted to a light amount corresponding to the measurement range of the light receiving portion 400. Note that the switching time TS is not limited to 1 ms and 0.5 ms, and may be arbitrarily set according to the shapes of the shutter 500 and the optical path 230, the characteristics of the switching speed of the shutter 500, and the like. Specifically, for example, the switching time TS is 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 ms, and may be within a range between any two of the numerical values exemplified herein.

In addition, the time set as the switching time TS is not limited to the first switching time TS1 and the second switching time TS2, and three or more times may be set. Specifically, for example, the times set as the switching time TS are 1, 2, 3, 4, 5, 6, 7, 8, 9, 10, 11, 12, 13, 14, 15, 16, 17, 18, 19, or 20, and may be within a range between any two of the numerical values exemplified herein.

### Method for using inspection apparatus 1

Next, a method for using the inspection apparatus 1 will be described with reference to other drawings. FIGS. 11-16 are cross-sectional views each schematically showing the inspection apparatus 1 including the light amount measuring device 200. In the following, an example of a method for using the time-resolved fluorescence measuring device 201 will be described, taking as an example a case where the inspection apparatus 1 including the time-resolved fluorescence measuring device 201, which is an example of the light amount measuring device 200, quantitatively inspects an antigen concentration in a specimen using the inspection tool 900.

[1] First, as shown in FIG. 11, the inspection tool 900 is set on the placement part 2 of the inspection apparatus 1. Here, as shown in FIG. 11, the intersection of an optical axis OA3 of the LED 310 and an optical axis OA4 of the PMT 410 is preferably set to be positioned inside the reaction detection section 912 of the inspection tool 900 placed on the placement part 2. According to such an aspect, the fluorescence amount of fluorescence from fluorescent particles (an example of the fluorescent material) included in the inspection tool 900 can be more accurately measured by the PMT 410 (hereinafter, also referred to as "photon counting"). Note that the inspection apparatus 1 may be configured such that, after the inspection tool 900 is set at a predetermined position of the inspection apparatus 1, an arbitrary drive mechanism is controlled by the controller 93, so that the inspection tool 900 moves and is set on the placement part 2.

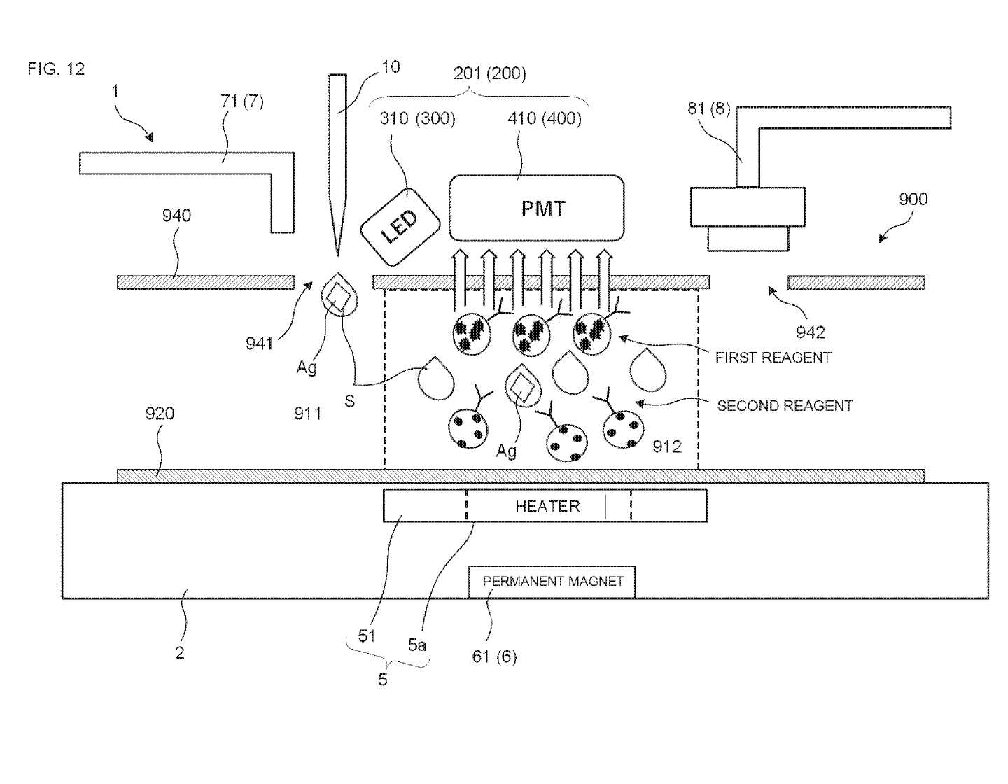

In this case, when the LED 310 irradiates the reaction detection section 912 with the excitation light, the reaction detection section 912 is in a state where the number of fluorescent particles present in the reaction detection section 912 is the largest. Thus, based on the control by the controller 93, the fluorescence from the fluorescent particles may be received by the PMT 410 to perform photon counting with setting A in which the amount of light received becomes the smallest.

[2] Next, as shown in FIG. 12, a sample S obtained by diluting a specimen with a diluent is supplied into the chamber 911 using a micropipette 10, a dropper, or the like. At this time, the sample S permeates into the chamber 911 by capillary action, and a dried reagent set containing the first reagent and the second reagent is dissolved by the sample S.

As the buffer solution for the diluent, for example, it is possible to use a buffer solution similar to those stated as the buffer solution used for preparing the dispersion liquid described above.

Furthermore, in order to effectively cause an antigen-antibody reaction, it is preferable to contain approximately 150 mM NaCl in the diluent.

It is preferable to add a protein denaturant into the diluent used for diluting the specimen.

The concentration (final concentration) of the protein denaturant in the sample S (in the specimen) obtained by diluting the specimen with the diluent is preferably 1 M or less, more preferably about 0.01 M or more and 1 M or less, and still more preferably about 0.1 M or more and 0.5 M or less.

Examples of the protein denaturant include guanidine hydrochloride, guanidine thiocyanate, potassium thiocyanate, sodium thiocyanate, and urea.

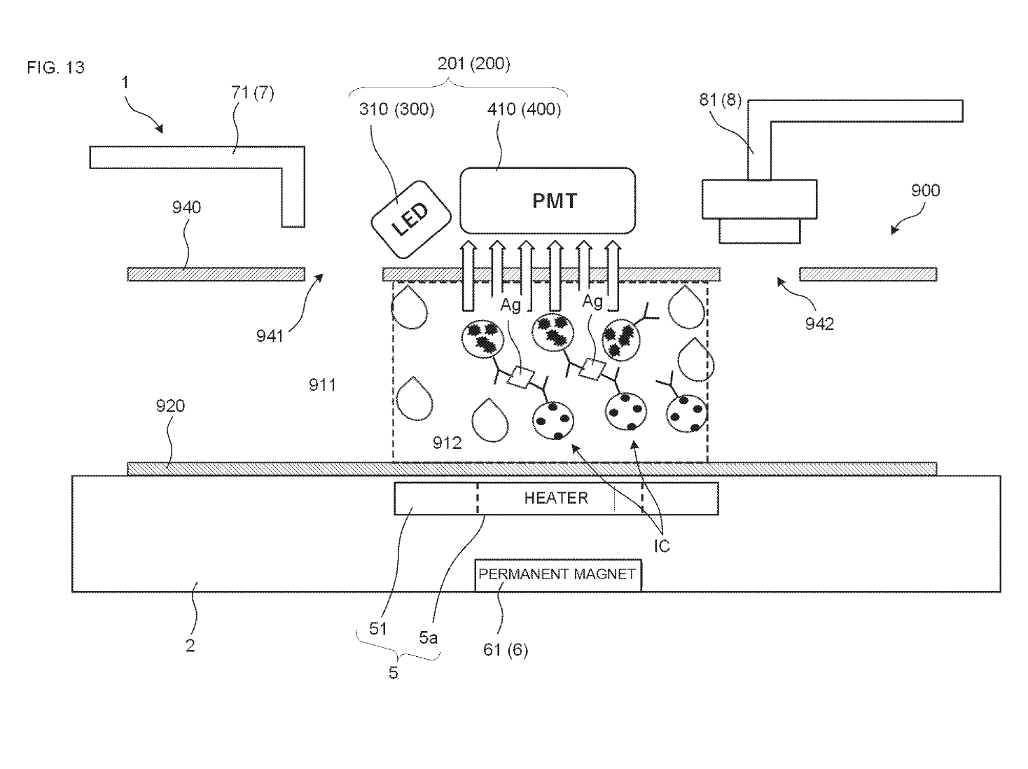

Here, examples of the specimen include urine, lymph fluid, blood, plasma, serum, saliva, cervical secretion, vaginal secretion, nipple discharge, breast milk, synovial fluid, semen, seminal plasma, feces, sputum, cerebrospinal fluid, tears, mucus, interstitial fluid, follicular fluid, amniotic fluid, aqueous humor, vitreous humor, peritoneal fluid, ascites, sweat, and the like.

[3] Next, as shown in FIG. 13, the liquid in the reaction detection section 912 is heated by the heater 51 under control of the controller 93,. Thereby, when the antigen Ag is present in the specimen, an antigen–antibody reaction occurs, and an immune complex IC is formed.

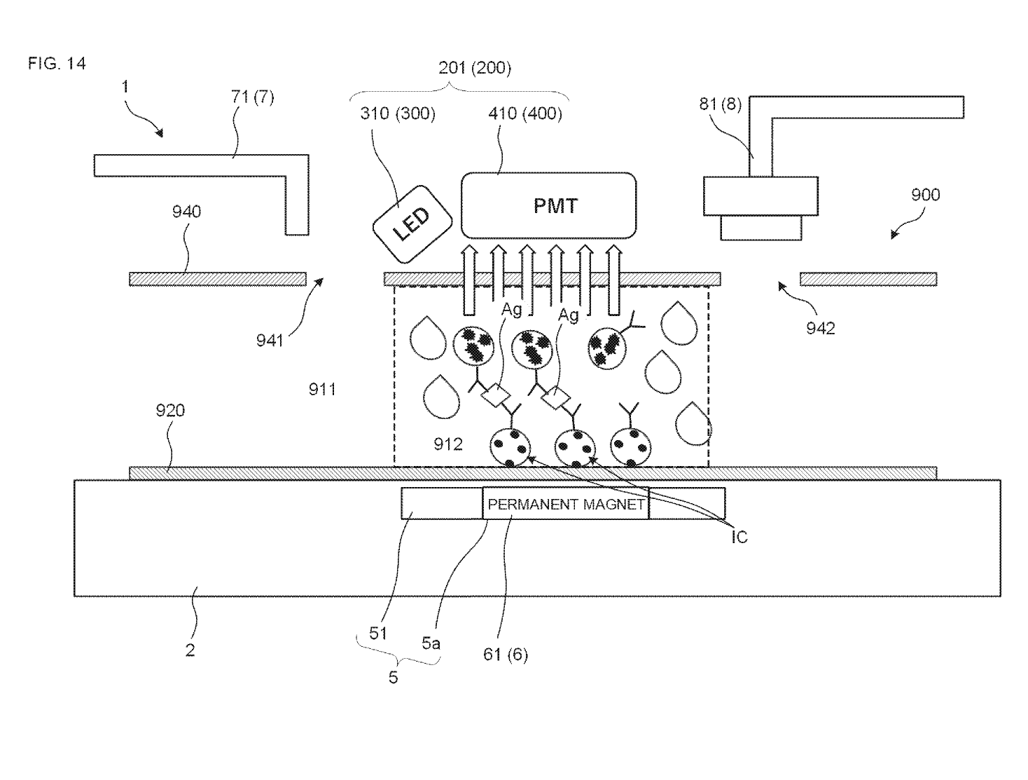

The heating temperature (reaction temperature) is preferably about 25° C or more and 45° C or less, and the heating time (reaction time) is preferably about 30 seconds or more and 100 seconds or less.

[4] Next, as shown in FIG. 14, the permanent magnet 61 is brought close to the inspection tool 900 by being passed through a through hole provided in the heater 51. Accordingly, magnetic particles are attracted by the permanent magnet 61 to capture the immune complex IC and the second reagent.

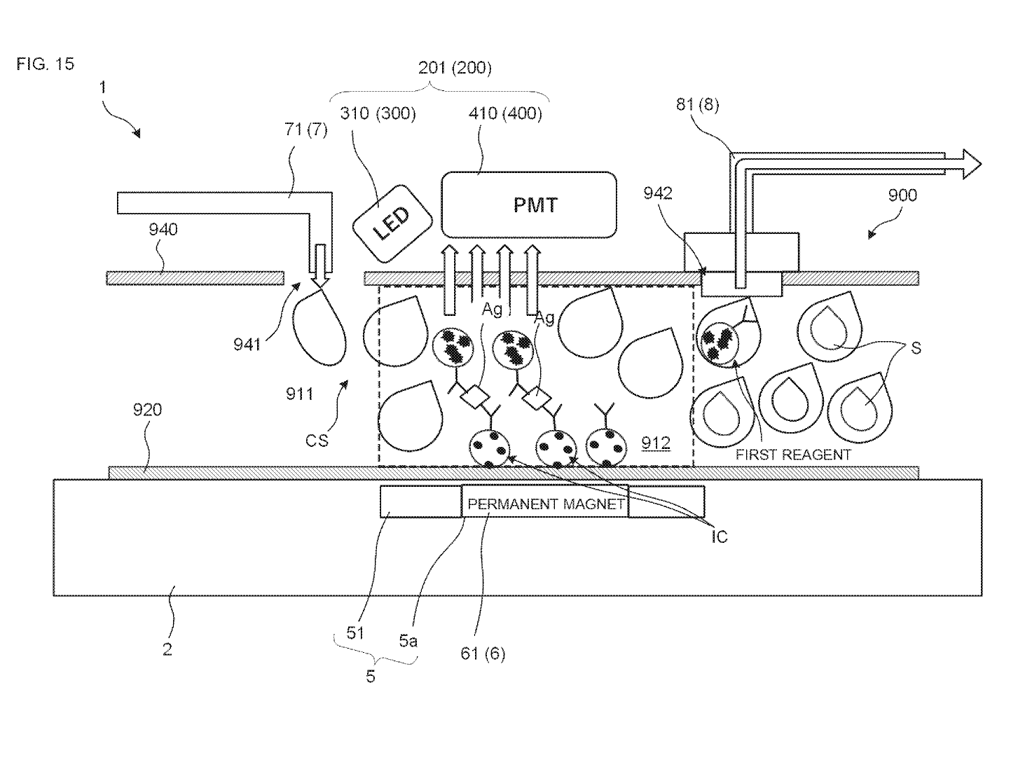

At this time, the permanent magnet 61 may be moved within the range of the chamber 911 along a longitudinal direction (the front-rear direction in FIG. 3) of the inspection tool 900.

[5] Next, as shown in FIG. 15, after the permanent magnet 61 is stopped, the removal nozzle 81 is brought close to the inspection tool 900 and is brought into close contact with the liquid suction port 942. Further, the cleaning solution supply nozzle 71 is brought close to the inspection tool 900, and its tip (lower end) is positioned above the liquid supply port 941.

In this state, a few drops of the cleaning solution CS are dropped from the cleaning solution supply nozzle 71 into the chamber 911 to be supplied, and a waste liquid is sucked and removed from the chamber 911 by the removal nozzle 81. Thus, the first reagent and the sample S that have not contributed to the antigen–antibody reaction can be discarded.

At this time, the supply amount of the cleaning solution CS is set to be greater than or equal to the removal amount of the waste liquid, and cleaning is performed in a state where the chamber 911 is always filled with the cleaning solution CS. In addition, it is preferable that the flow rate during waste liquid collection (liquid suction) be set to an extent that does not cause the immune complex IC to detach from within the chamber 911.

As the buffer solution for the cleaning solution CS, it is possible to use a buffer solution similar to those stated as the buffer solution used for preparing the dispersion liquid described above. Furthermore, it is preferable to contain approximately 150 mM NaCl also in the cleaning solution CS.

Furthermore, it is preferable to add a protein denaturant also into the cleaning solution CS. The concentration of the protein denaturant in the cleaning solution CS is preferably 1 M or less, more preferably approximately 0.01 M or more and 1 M or less, and still more preferably approximately 0.1 M or more and 0.5 M or less. In particular, it is most preferable to match the concentration of the protein denaturant in the cleaning solution CS with the concentration (final concentration) of the protein denaturant in the sample S obtained by diluting the specimen with the diluent.

Examples of the protein denaturant include guanidine hydrochloride, guanidine thiocyanate, potassium thiocyanate, sodium thiocyanate, and urea.

In this case, when the LED 310 irradiates the reaction detection section 912 with excitation light, the number of fluorescent particles present in the reaction detection section 912 gradually decreases as the waste liquid is sucked and removed from within the chamber 911. Thus, based on the control by the controller 93, setting A may be changed to setting B, and fluorescence from the fluorescent particles may be received by the PMT 410 to perform photon counting. This allows the fluorescence from the fluorescent particles to be adjusted to a light amount corresponding to the measurement range of the light receiving portion 400.

In this cleaning, it is preferable to repeat multiple cycles, with one cycle including a supply operation of the cleaning solution CS from the cleaning solution supply nozzle 71 into the reaction detection section 912 and a removal operation of the waste liquid from the reaction detection section 912 by the removal nozzle 81.

When multiple cycles are repeated, the number of repetitions is preferably about 2 or more and 10 or less, more preferably about 3 or more and 8 or less, and still more preferably about 4 or more and 6 or less. This makes it possible to accurately measure the antigen concentration while preventing the overall measurement time from being extended.

[6] Next, the cleaning solution supply nozzle 71 and the removal nozzle 81 are moved away from the inspection tool 900.

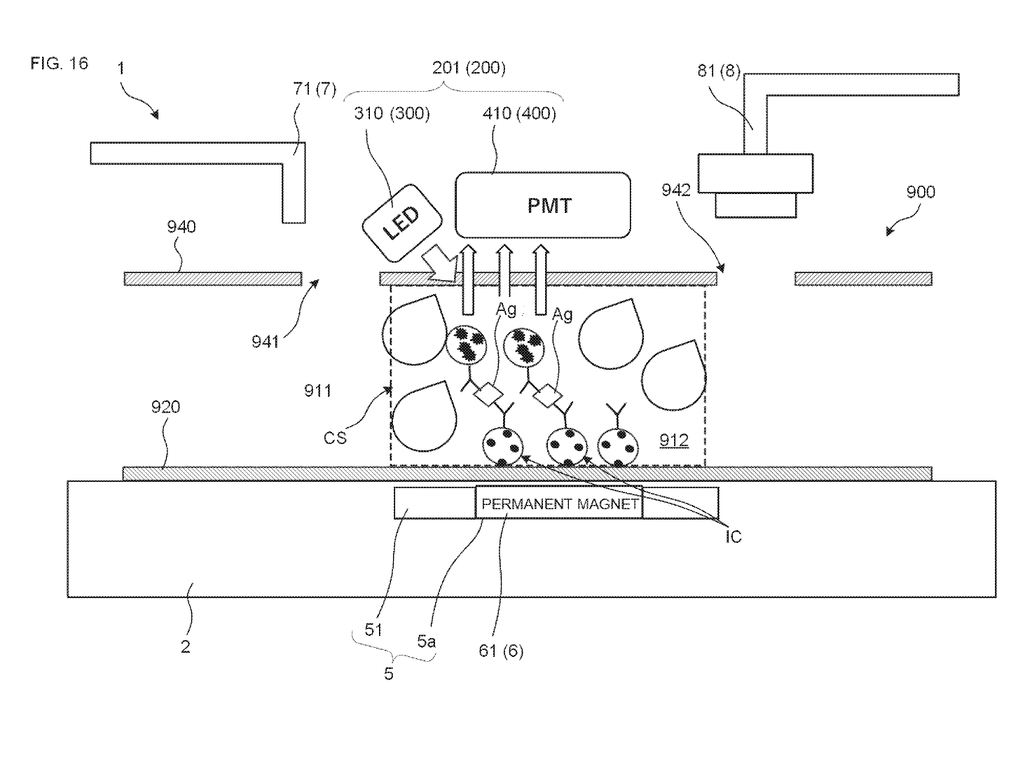

As shown in FIG. 16, in a state where the chamber 911 is filled with the cleaning solution CS, the LED 310 irradiates the reaction detection section 912 with excitation light, and the PMT 410 receives fluorescence from the fluorescent particles to perform photon counting.

In this case, the reaction detection section 912 is in a state where the number of fluorescent particles present in the reaction detection section 912 is the smallest. Thus, the setting may be changed from setting B to setting C or setting D based on the control by the controller 93, and the fluorescence from the fluorescent particles may be received by the PMT 410 to perform photon counting. This allows the fluorescence from the fluorescent particles to be further adjusted to a light amount corresponding to the measurement range of the light receiving portion 400.

In this manner, the time-resolved fluorescence measuring device 201 mounted on the inspection apparatus 1 adjusts the amount of fluorescence from the fluorescent material to a light amount corresponding to the measurement range of the PMT 410 by appropriately changing the setting according to the state of fluorescence from the fluorescent particles.

### Others

Although the above embodiment is described as the configuration of the inspection apparatus 1, a program may be provided to cause a computer to execute processing of the controller 93 in the inspection apparatus 1. That is, this program is configured to cause a computer to execute irradiation processing, light receiving processing, switching processing, and measurement processing. In the irradiation processing, the object is irradiated with excitation light. In the light receiving processing, light passing through the optical path 230 is received. The optical path 230 is a path through which light emitted from the object passes. In the switching processing, an open state M1 that allows passage of light and a blocked state M2 that does not allow passage of light are switched. In the measurement processing, a light amount of light passing through the optical path 230 is measured while repeatedly switching between the open state M1 and the blocked state M2. According to such an aspect, the amount of light emitted from the object can be adjusted to a light amount corresponding to the measurement range of the light receiving portion 400 through information processing by a distributable program.

In the above embodiments, the case where the light amount measuring device 200 is mounted on the inspection apparatus 1 has been described. However, the present disclosure is not limited thereto, and the light amount measuring device 200 may be mounted on an apparatus other than the inspection apparatus 1. In addition, although the case where the control device 9 is mounted on the inspection apparatus 1 has been described as an example, the light amount measuring device 200 may include the control device 9.

In the above embodiments, the case where the light amount measuring device 200 detects switching between the open state M1 and the blocked state M2 by the position detection sensor 600 has been described. However, the present disclosure is not limited thereto, and the light receiving portion 400 may detect switching between the open state M1 and the blocked state M2. That is, the light amount measuring device 200 does not necessarily include the position detection sensor 600. Specifically, the light amount measuring device 200 may detect switching between the open state M1 and the blocked state M2 accompanying rotation of the rotary shutter 510 by rotating the rotary shutter 510 at least once before measuring the light amount of fluorescence, and causing the light receiving portion 400 to detect a slight change in the light amount passing through the optical path 230. The detected information on the switching between the open state M1 and the blocked state M2 and the information on the rotation position by a stepping motor that is a drive mechanism of the rotary shutter 510 are grasped in association with each other. When the light amount measuring device 200 is measuring the light amount of fluorescence, the open state M1 and the blocked state M2 are detected based on the information on the rotation position by the stepping motor. According to such an aspect, a boundary between the through hole 512 and the blocking portion 513 can be grasped by the light receiving portion 400, and the position detection sensor 600 can be omitted. As a result, simplification of the mechanism of the light amount measuring device 200 can be expected.

In addition, the present disclosure may be provided in each of the following aspects.

(1) A light amount measuring device, comprising: a light emitting portion configured to irradiate an object with excitation light; an optical path through which light emitted from the object passes; a light receiving portion configured to receive the light passing through the optical path; and a shutter disposed on the optical path and configured to switch between an open state that allows passage of the light and a blocked state that does not allow passage of the light, the light amount measuring device being configured to measure a light amount of the light passing through the optical path while repeatedly switching between the open state and the blocked state.

According to such an aspect, the amount of light emitted from the object can be adjusted to the light amount corresponding to the measurement range of the light receiving portion.

(2) The light amount measuring device according to (1), wherein: the light emitting portion is configured to end irradiation with the excitation light at an irradiation end timing, the irradiation end timing is defined with an opening timing as a reference, and the opening timing is a timing of switching the shutter from the blocked state to the open state.

According to such an aspect, by adjusting the irradiation end timing, the amount of light emitted from the object can be adjusted to the light amount corresponding to the measurement range of the light receiving portion.

(3) The light amount measuring device according to (2), wherein: the irradiation end timing is substantially simultaneous with the opening timing.

According to such an aspect, by performing irradiation with the excitation light up to the timing substantially simultaneously with the opening timing, it is possible to increase the amount of light passing through the optical path. As a result, when the amount of light emitted from the object is small, the amount of light emitted from the object can be adjusted to the light amount corresponding to the measurement range of the light receiving portion.

(4) The light amount measuring device according to (2), wherein: the irradiation end timing is a timing that precedes the opening timing by an arbitrary time.

According to such an aspect, when the amount of light emitted from the object is large, the amount of light emitted from the object can be adjusted to the light amount corresponding to the measurement range of the light receiving portion.

(5) The light amount measuring device according to any one of (1) to (4), wherein: the light emitting portion is configured to emit the excitation light at a constant irradiation amount.

According to such an aspect, irradiation with the excitation light by the light emitting portion can be stabilized.

(6) The light amount measuring device according to any one of (1) to (5), wherein: the shutter is configured to repeatedly switch between the open state and the blocked state at an arbitrarily set switching time, the switching time being a time required to switch from the blocked state to the open state.

According to such an aspect, the amount of light emitted from the object can be adjusted to the light amount corresponding to the measurement range of the light receiving portion by the switching time.

(7) The light amount measuring device according to (6), wherein: the shutter is configured to switch between the open state and the blocked state by rotating, and the switching time is a time determined depending on a rotation speed of the shutter.

According to such an aspect, the switching time is changed by changing the rotation speed of the rotary shutter, and as a result, the amount of light emitted from the object can be adjusted to a light amount corresponding to the measurement range of the light receiving portion.

(8) The light amount measuring device according to (6) or (7), wherein: the switching time includes a first switching time and a second switching time, the first switching time being longer than the second switching time, and the shutter is configured to repeatedly switch between the open state and the blocked state at the first switching time or the second switching time.

According to such an aspect, based on the first switching time and the second switching time, the amount of light emitted from the object can be adjusted to the light amount corresponding to the measurement range of the light receiving portion.

(9) The light amount measuring device according to any one of (1) to (8), wherein: the object includes a fluorescent material, and the light receiving portion is configured to receive fluorescence emitted from the fluorescent material.

According to such an aspect, the amount of fluorescence emitted from the fluorescent material can be adjusted to the light amount corresponding to the measurement range of the light receiving portion.

(10) A non-transitory computer-readable storage medium storing a program configured to cause a computer to execute: irradiation processing of irradiating an object with excitation light; light receiving processing of receiving light passing through an optical path, the optical path being a path through which the light emitted from the object passes; switching processing of switching between an open state that allows passage of the light and a blocked state that does not allow passage of the light; and measurement processing of measuring a light amount of the light passing through the optical path while repeatedly switching between the open state and the blocked state.

According to such an aspect, the amount of light emitted from the object can be adjusted to the light amount corresponding to the measurement range of the light receiving portion through information processing by a program. Of course, the present disclosure is not limited to the above aspects.

As described above, various embodiments of the present disclosure have been described, but these are presented as examples and are not intended at all to limit the scope of the disclosure.

Novel embodiments can be implemented in various other forms, and various omissions, replacements, and modifications can be made within the scope of the spirit of the disclosure. The embodiments and its modifications are included in the scope and the spirit of the disclosure and are included in the scope of the disclosure described in claims and the equivalent scope thereof.

What is claimed is:

1. A light amount measuring device, comprising:
a light emitting portion configured to irradiate an object with excitation light;
an optical path through which light emitted from the object passes;
a light receiving portion configured to receive the light passing through the optical path; and
a shutter disposed on the optical path and configured to switch between an open state that allows passage of the light and a blocked state that does not allow passage of the light,
the light amount measuring device being configured to measure a light amount of the light passing through the optical path while repeatedly switching between the open state and the blocked state.

2. The light amount measuring device according to claim 1, wherein:
the light emitting portion is configured to end irradiation with the excitation light at an irradiation end timing,
the irradiation end timing is defined with an opening timing as a reference, and
the opening timing is a timing of switching the shutter from the blocked state to the open state.

3. The light amount measuring device according to claim 2, wherein:
the irradiation end timing is substantially simultaneous with the opening timing.

4. The light amount measuring device according to claim 2, wherein:
the irradiation end timing is a timing that precedes the opening timing by an arbitrary time.

5. The light amount measuring device according to claim 1, wherein:
the light emitting portion is configured to emit the excitation light at a constant irradiation amount.

6. The light amount measuring device according to claim 1, wherein:
the shutter is configured to repeatedly switch between the open state and the blocked state at an arbitrarily set switching time, the switching time being a time required to switch from the blocked state to the open state.

7. The light amount measuring device according to claim 6, wherein:
the shutter is configured to switch between the open state and the blocked state by rotating, and
the switching time is a time determined depending on a rotation speed of the shutter.

8. The light amount measuring device according to claim 6, wherein:
the switching time includes a first switching time and a second switching time, the first switching time being longer than the second switching time, and
the shutter is configured to repeatedly switch between the open state and the blocked state at the first switching time or the second switching time.

9. The light amount measuring device according to claim 1, wherein:
the object includes a fluorescent material, and
the light receiving portion is configured to receive fluorescence emitted from the fluorescent material.

10. A non-transitory computer-readable storage medium storing a program configured to cause a computer to execute:
irradiation processing of irradiating an object with excitation light;
light receiving processing of receiving light passing through an optical path, the optical path being a path through which the light emitted from the object passes;
switching processing of switching between an open state that allows passage of the light and a blocked state that does not allow passage of the light; and
measurement processing of measuring a light amount of the light passing through the optical path while repeatedly switching between the open state and the blocked state.
